(19) United States
(12) Patent Application Publication
(10) Pub. No.: US 2013/0204805 A1
(43) Pub. Date: Aug. 8, 2013

(54) SYSTEM FOR VALUING INVESTMENT OPPORTUNITIES

(71) Applicant: Synchrony Venture Management, Boston, MA (US)

(72) Inventor: Adam D. Caper, Boston, MA (US)

(73) Assignee: Synchrony Venture Management, Boston, MA (US)

(21) Appl. No.: 13/763,542

(22) Filed: Feb. 8, 2013

Related U.S. Application Data
(60) Provisional application No. 61/596,280, filed on Feb. 8, 2012.

(51) Int. Cl. G06Q 40/06

(52) U.S. Cl. CPC G06Q 40/06
USPC 705/36 R

(57) ABSTRACT

A system, comprising instructions executing on at least one computing device, to evaluate investment opportunities for an enterprise and calculate, for each investment opportunity, a strategic value of the investment opportunity to the enterprise and an estimated financial return of the investment. In some embodiments, in evaluating the strategic value of an investment opportunity, the opportunity evaluation system may assign to the investment opportunity one or more values with which the system was configured prior to receipt of information regarding the investment opportunity. The values that are assigned may be determined by the opportunity evaluation system in advance of evaluating investment opportunities, based at least in part on information collected from people affiliated with the enterprise. By determining the values in advance and evaluating each investment opportunity based on these predetermined values, the opportunity evaluation system may provide an objective and unbiased review of investment opportunities for the enterprise.

### CROSS-REFERENCE TO RELATED APPLICATIONS

The present application claims priority under 35 U.S.C. §119(e) to U.S. Provisional Patent Application Ser. No. 61/596,280, titled “System for valuing corporate venture investments” and filed on Feb. 8, 2012, the entirety of which is incorporated herein by reference.

### BACKGROUND

Many corporations make investments in other companies, which may include early-stage companies. Such investments are often referred to as corporate venture capital investments. Although similar to traditional venture capitalists in that corporate venture capitalists seek financial returns, corporate venture capitalists have additional considerations when evaluating potential investments. Those considerations vary depending on the goals of a corporation. Investments made by corporate venture capitalists are generally referred to as “strategic investments” for the corporation, as a corporate venture capitalist may seek to make investments according to a strategy that will aid the corporation.

A corporate venture capitalist may, for example, seek to invest in companies that hope to produce a product or provide a service that the corporate venture capitalist perceives has the potential, if used by the corporation, to provide a competitive advantage to the corporation. Other corporate venture capitalists may be more interested in investing in companies that are developing technologies that are potentially disruptive to their businesses as a means of managing so-called “disruption risk.” Still others may seek investments that address an emerging market that the corporation has not itself entered, where an “emerging” market may be a new market space, a new technology-capability, or an as-yet-to-be-entered geographic market. Another corporate venture capitalist may seek to gain an advantage for the corporation in attempting an acquisition aided by the investment, such as an acquisition of a company in which the corporation has invested or an acquisition of another company using information derived from an investment.

In sum, there are a variety of aims of corporate venture capitalists. Those aims may be described as strategic in nature and those aims may vary from corporation to corporation or within a single corporation from time-to-time as priorities, markets, technologies, and managements change.

Corporate venture capitalists spend significant time and resources investigating companies that represent “opportunities” for investment by the corporation.

### SUMMARY

In one embodiment, there is provided a method of operating at least one computing device to evaluate an investment opportunity to identify, for an enterprise, a value of the investment opportunity to the enterprise. The method comprises calculating, for the investment opportunity, a first numeric value indicating a strategic value of the investment opportunity to the enterprise. Calculating the first numeric value comprises operating at least one processor to receive, from at least one storage medium, a classification of the investment opportunity according to a plurality of capability deficits, the classification classifying the investment opportunity in one or more of the plurality of capability deficits. Calculating the first numeric value further comprises operating the at least one processor to receive, from the at least one storage medium, information regarding the one or more capability deficits, the information regarding the one or more capability deficits identifying, for each capability deficit, a numeric estimate of an impact that investments in the capability deficit will have in assisting the enterprise in achieving at least one goal of the enterprise. Calculating the first numeric value further comprises operating the at least one processor to calculate the first numeric value indicating the strategic value of the investment opportunity to the enterprise based at least in part on the one or more numeric estimates of the one or more capability deficits in which the investment opportunity is classified. The method further comprises determining, using the at least one processor, a second numeric value indicating an estimated financial return on an investment in the investment opportunity and storing, in the at least one storage medium, information regarding the investment opportunity, the information for the investment opportunity comprising the first numeric value and the second numeric value.

In another embodiment, there is provided At least one computer-readable storage medium having encoded thereon computer-executable instructions that, when executed by at least one computing device, cause the at least one computing device to carry out a method of operating a system for evaluating investment opportunities for an enterprise. The method comprises establishing a plurality of capability deficits according to which investment opportunities for the enterprise are to be classified, wherein establishing the plurality of capability deficits comprises setting, for each category, a numeric estimate that investments in the capability deficit will assist the enterprise in achieving one or more goals of a plurality of goals for the enterprise. The method further comprises scoring an investment opportunity to provide an indication of a value the investment opportunity presents to the enterprise, wherein scoring the investment opportunity comprises determining a strategic value the investment opportunity presents to the enterprise and determining an estimated financial return on investment in the investment opportunity, wherein determining the strategic value presented by the investment opportunity comprises performing a calculation involving a first numeric estimate corresponding to a first capability deficit, of the plurality of capability deficits, into which the investment opportunity is classified.

In a further embodiment, there is provided an apparatus comprising at least one processor and at least storage medium having encoded thereon executable instructions that, when executed by the at least one processor, cause the at least one processor to carry out a method of operating a system for evaluating investment opportunities for an enterprise. The method comprises establishing a plurality of capability deficits according to which investment opportunities for the enterprise are to be classified, wherein establishing the plurality of capability deficits comprises setting, for each capability deficit, a numeric estimate that investments in the capability deficit will assist the enterprise in achieving one or more goals of a plurality of goals for the enterprise. The method further comprises scoring an investment opportunity to provide an indication of a value the investment opportunity presents to the enterprise, wherein scoring the investment opportunity comprises determining a strategic value the investment opportunity presents to the enterprise and determining an estimated financial return on investment in the investment opportunity, wherein determining the strategic value presented by the investment opportunity comprises performing a calculation involving a first numeric estimate corresponding to a first capability deficit, of the plurality of capability deficits, into which the investment opportunity is classified.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of some components of an opportunity evaluation system in accordance with some embodiments;

FIG. 2 is a flowchart of a process for evaluating investment opportunities that may be implemented in an opportunity evaluation system in some embodiments;

FIGS. 3A and 3B are examples of graphs that may be produced by an opportunity evaluation system in some embodiments for providing a graphical comparison of investment opportunities;

FIG. 4 is a flowchart of a process for calculating a strategic value to an enterprise of an investment opportunity that may be implemented in an opportunity evaluation system in some embodiments;

FIG. 5 is a flowchart of a process for calculating a numeric estimate of an impact that investments in a capability deficit will have in assisting an enterprise in achieving goals, which may be implemented in an opportunity evaluation system in some embodiments;

FIG. 6 is a flowchart of a process for establishing goals of an enterprise, which may be implemented in an opportunity evaluation system in some embodiments;

FIG. 7 is a flowchart of a process for establishing capability deficits for an enterprise, which may be implemented in an opportunity evaluation system in some embodiments;

FIG. 8 is a flowchart of a process for establishing capability groups for an enterprise, which may be implemented in an opportunity evaluation system in some embodiments;

FIG. 9 is a flowchart of a process for identifying capability deficits for an enterprise based on an evaluation of capability groups, which may be implemented in an opportunity evaluation system in some embodiments;

FIG. 10 is a flowchart of a process for evaluating an investment opportunity to determine whether values of the investment opportunity exceeds thresholds set for the enterprise, which may be implemented in an opportunity evaluation system in some embodiments;

FIG. 11 is a flowchart of a process for identifying, from evaluated investment opportunities, the investment opportunities that appear to be of value to an enterprise, which may be implemented an opportunity evaluation system in some embodiments;

FIG. 12 is a flowchart of a process for creating a graphical comparison of investment opportunities for presentation to a user, which may be implemented an opportunity evaluation system in some embodiments;

FIG. 13 is a flowchart of a process for identifying differences between goals and expectations of an enterprise regarding investment strategy and investments made by the enterprise, which may be implemented in an opportunity evaluation system in some embodiments;

FIG. 14 is a flowchart of a process for identifying industry trends, which may be implemented an opportunity evaluation system in some embodiments; and

FIG. 15 is a block diagram of a computing device on which an opportunity evaluation system may execute in some embodiments.

### DETAILED DESCRIPTION

Applicant has recognized and appreciated that an evaluation of investment opportunities can be facilitated through a computer-based opportunity evaluation system that can provide objective indications of whether investment opportunities are strategically and/or financially valuable to an enterprise. Such an opportunity evaluation system may quantize a value of an investment opportunity to the enterprise, including the non-financial or “strategic” value. The system may quantize the value of the investment opportunity at least in part by, in some embodiments, computing the value of an investment opportunity to an enterprise based on information regarding the goals of an enterprise and expectations of the enterprise regarding types of investments that may assist the enterprise in achieving the goals of the enterprise. Some computer-based opportunity evaluation systems, using techniques described herein, may compute the value of an investment opportunity in various ways, which may include one or more of computing a degree to which an investment opportunity may assist an enterprise gain an advantage over competitors, assist an enterprise protect itself from encroachment by marketplace players such as customers or suppliers, create new opportunities, or otherwise assist an enterprise in advancing strategic goals of the enterprise.

In some embodiments, the information regarding the goals and expectations on which the system bases its computations may be determined by the system during an initialization phase. The system may determine the information during the initialization phase based on input provided by multiple people affiliated with the enterprise, while in some embodiments the system may make use of information provided by a range of persons or entities, affiliated and/or unaffiliated with the enterprise. Input provided by people may or may not be aggregated or processed prior to input to the system. The goals and expectations of the enterprise may include information that is not related to any particular investment opportunity. The goals and expectations of the enterprise may instead represent estimates of people affiliated with the enterprise regarding the importance and/or potential of various types of investments that may be made, which may include information on characteristics of types of investment opportunities, or types of innovations offered by investment opportunities, that may be strategically beneficial to the corporation. The estimates of people affiliated with the enterprise may include perceptions and insights provided by the people, which may be based on expertise of those people including familiarity with the marketplace and/or technologies that are available or may be available in the marketplace.

In some embodiments, the opportunity evaluation system may determine, as information regarding a goal and/or an expectation of the enterprise, information regarding capability deficits of an enterprise. A capability deficit may correspond to a capability the enterprise lacks and that, if the enterprise did not lack, would assist the enterprise in achieving one, some, or all of the goals of the enterprise. In some embodiments, investment opportunities may be classified as relating to one or more capability deficits. The expectation of the enterprise regarding a capability deficit may include, for example, an estimate of an impact that, in general, investments in opportunities that are categorized in the capability deficit will have in assisting the enterprise in achieving one or more of the enterprise's goals. Such an estimate may be calculated as a numeric value. The opportunity evaluation system may compute such a numeric estimate based in part on the input provided by the people associated with the enterprise.

Once the opportunity evaluation system is configured with the information regarding the goals and expectations of the enterprise, during a production phase the opportunity evaluation system may receive input regarding an investment opportunity and compute a strategic value of the investment opportunity to the enterprise based on the information regarding the goals and expectations. A strategic value that an investment opportunity presents to the enterprise may represent an amount by which the investment opportunity is estimated to aid the enterprise in advancing a strategy of the enterprise or assisting the enterprise in changing or improving its tactics for achieving a strategy or a goal. In some embodiments, to evaluate an investment opportunity, the investment opportunity is classified into one or more capability deficits and the opportunity evaluation system may calculate, based on the capability deficits, a numeric value indicating a strategic value that the investment opportunity presents to the enterprise. For example, the system may calculate the strategic value based at least in part on information regarding each of at least a portion of the deficits into which the investment opportunity is classified. The information on the deficits may include the estimate of the impact that, in general, investments classified in the deficits will have in assisting the enterprise in achieving one or more of the enterprise's goals. Thus, in these embodiments, the system may compute during a production phase a numeric value indicating a strategic value of an investment to the enterprise based on the information with which the system was configured during the initialization phase.

Applicant has recognized and appreciated that opportunity evaluation systems operating in accordance with techniques described herein may provide investors, such as corporate venture capitalists, with a tool for consistently and quantitatively evaluating investment opportunities and enabling an unbiased comparison between investment opportunities. Strategic investors currently evaluate potential investments when determining whether and how to invest. However, Applicant has recognized and appreciated that these investors typically review the potential investments in a way that is highly subjective and susceptible to bias on the part of the person reviewing a specific potential investment. Using currently-available procedures, these investors rely primarily on information that is qualitatively descriptive with respect to potential strategic value of investments. Applicant has recognized and appreciated that this qualitatively descriptive information varies widely as to structure, quality and depth, and can only be interpreted in a manual and highly subjective manner to provide information on a value of a particular investment. The manual and subjective interpretation at the heart of the currently-available procedures often results in potential investments being assessed inconsistently and in a biased way, and can leave open a question as to the objectivity of the investigation process due to so-called “observer bias.” In particular, Applicant has recognized and appreciated that varying criteria are applied to potential investments when two different opportunities are evaluated by the same person or group, and varying criteria are applied when multiple people are reviewing potential investments independently. Applicant has recognized and appreciated that such inconsistent review processes may hamper an investor's ability to invest in a way that will advance the investor's goals.

Additionally, Applicant has recognized and appreciated that currently-available procedures for evaluating potential investments may not capture the thoughts of an enterprise's stakeholders other than the reviewer(s) or may make it difficult, time-consuming, and/or expensive to engage a variety of reviewers in determining the potential appeal of an investment opportunity. Thus, investment decisions may be unacceptably influenced by the reviewer(s)'s thoughts on what qualifies a valuable investment, and may not reflect the opinions of the enterprise as a whole or of other people affiliated with the enterprise. Applicant has recognized and appreciated that this may also hamper an enterprise's ability to advance its goals through investment, as considering the opinions of only one reviewer or a small group of reviewers, of varying levels of expertise in the often many facets which must be considered when investigating a potential investment, may limit the types of investments that may be reviewed for potential value to the enterprise. The types of investments may be limited based not only by what the reviewer(s) consider potentially valuable, but may also be limited by the time available to the reviewer(s) for evaluating potential investments, or the inadequacy of methods of communicating perceived value, or varying levels of skill on the part of varying reviewers in appreciating the various facets to be considered.

In some embodiments, the opportunity evaluation system may compute, based on information regarding goals and expectations of an enterprise, one or more numeric values indicating a value of an investment opportunity to an enterprise. Applicant has recognized and appreciated that, through use of such information, the opportunity evaluation system of some embodiments may enable a consistent and unbiased review of investment opportunities.

Such a system may be useful to any of various types of enterprise evaluating any of various types of investment opportunities, as embodiments are not limited in this respect. An investment opportunity may, in some cases, be an innovation opportunity, as an investment opportunity may be related to the development and/or commercialization of an innovation. For example, in some embodiments, investment opportunities may be organizations that are seeking to develop and/or commercialize an idea, such as a technology innovation. An enterprise may also be any suitable person or organization that is seeking to make investment to achieve one or more goals of the enterprise. In some embodiments, for example, the enterprise may be a corporation. Accordingly, in some embodiments, an opportunity evaluation system operating in accordance with some of the techniques describes herein may assist a corporate venture capitalist in evaluating companies in which the corporate venture capitalist may invest to advance strategic priorities of a corporation. In other embodiments, an opportunity evaluation system operating in accordance with some of the techniques described herein may be used for selecting projects to fund for corporate research and development, for technology scouting, for mergers and acquisitions, for strategic planning, and for product development or other market-driven enhancements to an enterprise's portfolio of goods and services.

Various examples of ways in which an opportunity evaluation system may be implemented are discussed below. It should be appreciated, however, that embodiments are not limited to operating in accordance with these embodiments. In one commercial implementation, the opportunity evaluation system is embodied as the INNOVATION CAPITAL™ system (also called the TOTAL INNOVATION CAPITAL RETURNS™ system) available from Synchrony Venture Management of Boston, Mass.

In some embodiments, as discussed in more detail below, the opportunity evaluation system evaluates investment opportunities for their potential to advance goals of an enterprise. In the INNOVATION CAPITAL™ system, these goals are referred to as “Strategic Priorities.” As discussed below, in some embodiments, an opportunity evaluation system may define for the enterprise goals based on input provided by multiple people affiliated with an enterprise, such as officers, managers, and/or employees of the enterprise, customers of the enterprise, or experts tasked by the enterprise with assisting with developing a strategy for the enterprise or assisting with any other matter. In some such embodiments, the opportunity evaluation system may also compute an importance of a goal to the enterprise. The system may calculate the importance in any suitable manner, including based on input received from surveying the people on the importance of goals. In the INNOVATION CAPITAL™ system, the questions regarding the importance of a goal are questions regarding a “Significance” of a goal, and an importance of each Strategic Priority to the enterprise is termed the “Strategic Priority Rating.”

As also discussed in more detail below, in embodiments an opportunity evaluation system may collect information from people affiliated with the enterprise and evaluate investment opportunities in the context of capability groups and capability deficits for the enterprise. In the INNOVATION CAPITAL™ system, “Capabilities Groups” are groupings of Capabilities of an enterprise. A Capability of an enterprise may represent a process, skill, technology, or other technique that an enterprise may be able to use to achieve one or more of the Strategic Priorities of the enterprise, or to produce a product or service, or to contribute to the enterprise's purpose in any other way deemed useful by the enterprise. An enterprise may possess one or more Capabilities and may be able to identify one or more capability deficits. A capability deficit may be a Capability that the enterprise does not possess, and that may or may not be available, but that the enterprise estimates may be able to assist the enterprise in achieving one or more of the Strategic Priorities.

In some embodiments, investment opportunities may be classified according to innovations that are estimated to result from investment. In some such embodiments, innovations may include technological innovations. In these embodiments, some or all of the Capabilities may be related to a field of technology, and capabilities deficits for an enterprise may relate to a field of technology for which the enterprise estimates innovations may assist the enterprise in achieving one or more Strategic Priorities. In the INNOVATION CAPITAL™ system, at least some of the Capabilities are related to fields of technology and are therefore termed “Technologies.”

A Capabilities Group is a grouping of Capabilities and, as such, is related to one or more Capabilities. The Capabilities may be grouped in any suitable manner, as embodiments are not limited in this respect. For example, when Capabilities relate to fields of technologies, related fields of technology may be grouped. In some embodiments, such as in the INNOVATION CAPITAL™ system, the Capabilities Groups may relate to an organizational structure of an enterprise. For example, a Capabilities Group of an enterprise may be related to a corporate division or research group that may be tasked with developing one or more Capabilities (e.g., Technologies) or achieving goals that may be fulfilled by one or more Capabilities, and the Capabilities Group may be related to these Capabilities.

In some embodiments, the opportunity evaluation system may begin an initialization phase with multiple Capabilities and one or more Capabilities Groups and may filter those Capabilities and/or Groups during the initialization phase. From this filtering, the opportunity evaluation system may identify Capabilities into which investment opportunities may be later classified for evaluation by the system. This filtering may be carried out in any suitable manner, examples of which are described below. In the INNOVATION CAPITAL™ system, the system may calculate for each Capability Group and/or Capability an estimate that there will be innovation in the Group/Capability. This estimate may be calculated by the system based on input provided by people affiliated with the enterprise in response to “Innovation Potential” questions. Groups/Capabilities may then be filtered based on these estimates. In addition, the opportunity evaluation system may determine, such as by receiving input from one or more people affiliated with the enterprise, which of the Capabilities represents a Capability that the enterprise already possesses and/or may soon possess. Capabilities that the enterprise does not current possess, that the enterprise possesses but which are deemed to be at risk of being inadequate to future needs of the enterprise, and/or that the enterprise will not soon possess may be “capability deficits” of the enterprise. These capability deficits may additionally or alternatively be identified by filtering the Capabilities based on Significance values determined by the system for each of the Capabilities. Thus, as a result of the filtering, the system may be able to identify those Capabilities that the enterprise lacks but that are estimated by the enterprise to have a high likelihood of innovation and that have been estimated as having a potentially high impact in assisting the enterprise in achieving one, some, or all of the Strategic Priorities of the enterprise. In the INNOVATION CAPITAL™ system, capabilities deficits that are identified by the system as a result of the filtering, and into which investment opportunities may be classified, are called “GAPPORTUNITIEST™.”

The opportunity evaluation system may also, in some embodiments, calculate for some or all capability estimates an estimate of an impact that, in general, investments classified in the capability deficit will have in assisting the enterprise achieve its goals. The system may calculate these numeric estimates during an initialization phase, based on input from stakeholders associated with the enterprise. This numeric estimate is termed a “GAPPORTUNITY™ Value” in the INNOVATION CAPITAL™ system. Exemplary ways of calculating a numeric estimate of an impact that, in general, investments in the capability deficit will have in assisting the enterprise in achieving one or more goals (e.g., a GAPPORTUNITY™ Value) are discussed below.

As discussed in more detail below, in some embodiments the opportunity evaluation system may determine a strategic value of an investment opportunity based at least in part on a classification of the investment opportunity into capability deficits. For example, the system may calculate the strategic value of an investment based on the numeric estimates associated with at least some of the capability deficits into which the investment opportunity is classified. For example, when an investment opportunity is classified according to one or more capability deficits (“GAPPORTUNITIES™,” using the terminology of the INNOVATION CAPITAL™ system), the system may use the numeric estimate(s) (“GAPPORTUNITY™ Values”) associated with some or all of these one or more capability deficits to calculate a numeric value indicating a strategic value of the investment opportunity to the enterprise. Though, other factors may be used by the system to determine the strategic value of an investment opportunity, as discussed in examples below.

Some illustrative embodiments are described below using the terminology of the INNOVATION CAPITAL™ system given above. It should be appreciated, however, that embodiments are not limited to operating in accordance with the INNOVATION CAPITAL™ system. In other embodiments, an opportunity evaluation system may determine and process enterprise goals, capability groups, and/or capability deficits in any suitable manner and may determine, for each investment opportunity, a strategic value that the investment opportunity presents to the enterprise and/or an estimated financial return of the investment opportunity.

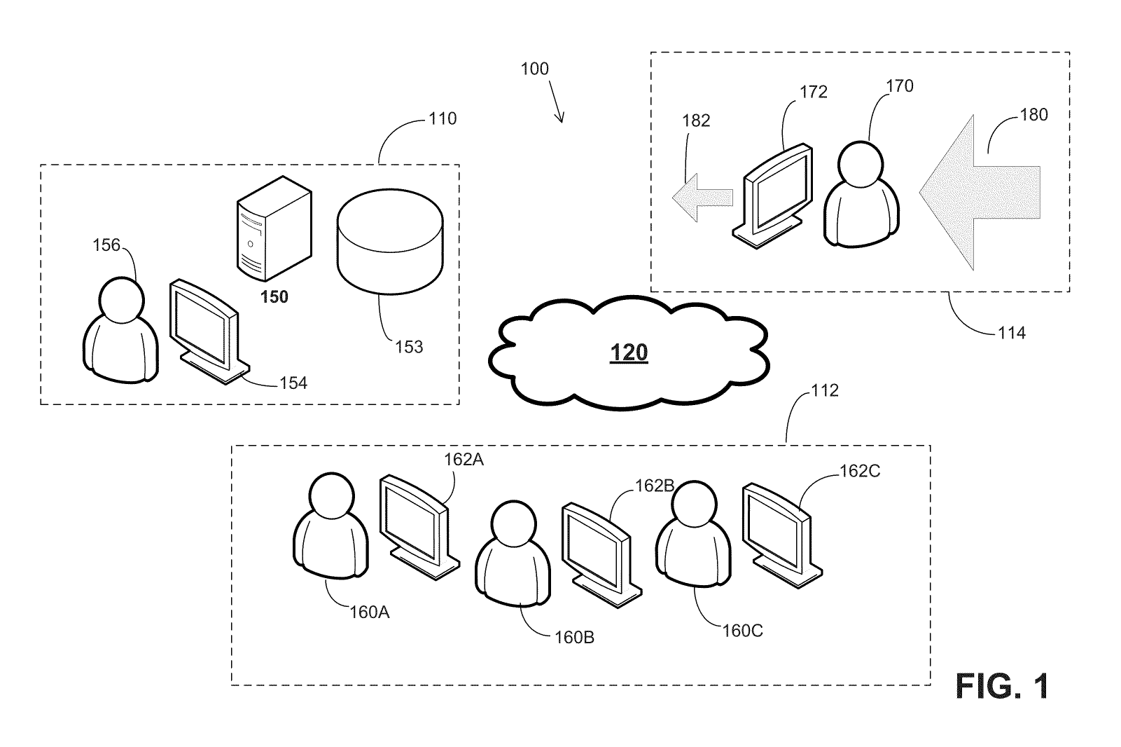

FIG. 1 illustrates a computing environment 100 in which some embodiments may operate. It should be appreciated, however, that embodiments are not limited to operating in an environment like the one illustrated in FIG. 1 and are not limited to implementing an opportunity evaluation system as described in connection with FIG. 1.

As illustrated in FIG. 1, the computing environment 100 includes a development environment 110, an enterprise environment 112, and a production environment 114. Various components of the computing environment 100 may be connected to one another via one or more computer communication networks 120. The network(s) 120 may be any suitable wired and/or wireless networks, including a Local Area Network (LAN), a wide-area network (WAN) for an enterprise, and/or the Internet, as embodiments are not limited in this respect.

The development environment 110 includes an opportunity evaluation system 150, which may be implemented at least in part as one or more computing devices executing instructions. The opportunity evaluation system 150 evaluates investment opportunities to compute a value of an investment opportunity to an enterprise. More particularly, the opportunity evaluation system 150 may calculate one or more numeric values for an investment opportunity that, individually and/or collectively, indicate a value that the investment opportunity presents to an enterprise.

Embodiments are not limited to operating with any particular type of investment opportunity or enterprise. In the example of FIG. 1, and in other examples below, an enterprise may be an organization that makes investments in other organizations as part of achieving its goals, and an investment opportunity may be another organization in which the organization may invest. An enterprise may be, for example, a corporation or other business entity, or may be any suitable organizational unit of a business entity, such as a corporate division or a research group. For example, an investment opportunity for the corporation may be a company that is seeking to develop and commercialize a technology innovation. The enterprise may be able to invest in the company in any suitable manner of investing in a company, as embodiments are not limited in this respect. In some embodiments, the enterprise may be able to invest in a company with a monetary and/or in-kind investment for which the enterprise will receive an ownership stake in the company (e.g., publicly- or privately-traded stock in the company, or any other suitable manner of transferring fractions of ownership in a company), an opportunity to be an exclusive or non-exclusive customer of the company, or any other suitable compensation. For example, the enterprise may provide money to a commercial organization in exchange for an ownership stake in the commercial organization.

The enterprise may make any suitable investment for any suitable reason, as embodiments are not limited in this respect. Some enterprises invest in other companies in the hope that an investment will assist the enterprise in achieving one or more of the enterprise's goals. For example, an enterprise may have a goal of reducing an environmental impact of its manufacturing processes. The enterprise could, in furtherance of this goal, direct some of its own physical, monetary, and human resources to studying and developing ways of reducing the environmental impact. However, other companies may be developing technologies that, if successful, could help the enterprise reduce its environmental impact. If these other companies are successful, then the enterprise could leverage the technologies developed by these companies to achieve its goal with less (or even no) allocation of physical or human resources than if the enterprise had developed the technology itself. The enterprise may therefore invest in one or more of these other companies, such as providing funds to the companies, becoming a customer of the companies, or engaging with the companies in any of multiple ways that may be beneficial to an enterprise, to assist the companies in developing the technologies.

An enterprise may be presented with a number of investment opportunities of varying value to the enterprise, and may have difficulty evaluating the investment opportunities consistently and objectively. The opportunity evaluation system 150 may assist the enterprise in selecting investment opportunities in which to invest by scoring the investment opportunities according to a value each opportunity presents to the enterprise. In some embodiments, the opportunity evaluation system 150 may score the investment opportunities based at least in part on a strategic value each opportunity presents to the enterprise, which may be an estimate of an impact an investment opportunity will have in assisting the enterprise achieve one or more of the enterprise's goals.

To score investment opportunities according to a value each opportunity presents to the enterprise, the opportunity evaluation system 150 may be configured with information regarding the enterprise. The information regarding the enterprise may include, for example, goals and/or expectations of the enterprise. The information regarding the enterprise may be stored by the opportunity evaluation system 150 in one or more data stores 153.

The goals of the enterprise may include any suitable objectives for an enterprise, including strategic objectives for the enterprise. Strategic objectives may include any suitable objectives for advancing a purpose of the enterprise or assisting the enterprise in achieving its purpose. In some cases, a purpose of an enterprise may be commercial, such as collecting a profit for offering goods and services. In other cases, a purpose of an enterprise may be non-commercial, such as in the case of a non-profit enterprise. Non-commercial purposes may include philanthropic or academic purposes, or any other purpose. Accordingly, goals of an enterprise may vary between enterprises, depending on a purpose of the enterprise. In some embodiments, goals of an enterprise may include commercial goals that relate to a manner in which the enterprise buys and/or sells good or services or otherwise spends or takes in money and organizational goals that relate to a manner in which the enterprise conducts operations. The goals may relate to adjusting current characteristics of the enterprise, such as increasing a profitability of the enterprise or decreasing waste of the enterprise. Other examples of goals are given below.

Expectations of an enterprise may relate to the enterprise's expectations of how outside influences may assist (which, in some cases, may mean not assisting, i.e., hindering) the enterprise in achieving its goals. The enterprise's expectations may be set, for example, based on the expectations of people affiliated with the enterprise, including based on what those people perceive the expectations of the enterprise to be. The expectations of the enterprise may relate to any suitable outside influences, including current market forces or anticipated market forces. The expectations of the enterprise may relate to a manner in which an outside influence is expected to change over time. The expectations may be expressed as an amount by which an outside influence may assist (or hinder, such as in the case that an outside influence may provide negative assistance) the enterprise in achieving one or more (or all) of the enterprise's goals. The expectations may additionally or alternatively be expressed as a likelihood that the outside influence will assist (including hinder) the enterprise, which may be a likelihood that an outside influence will materialize if the outside influence is an anticipated influence. In some embodiments, at least some of the expectations of an enterprise may relate to types of innovations, such as innovations in fields of technology. Expectations of an enterprise related to a field of technology may include information on a likelihood that there will be innovation in the field of technology and an amount by which the innovation is expected to assist the enterprise in achieving one, some, or all of the enterprise's goals.

In some embodiments, at least some of the information regarding the enterprise may be provided to the opportunity evaluation system 150 by a user 156 operating a computing device 154. For example, the computing device 154 may include a user interface by which the user 156 can be prompted to enter information regarding the enterprise, which may include goals of the enterprise and/or expectations of the enterprise. The information regarding the enterprise may be any suitable information compiled from any suitable source. For example, the user 156 may be a consultant hired by the enterprise to assist the enterprise with evaluating investment opportunities. The user 156 may speak or otherwise interact with one or more people affiliated with the enterprise regarding goals and/or expectations of the enterprise and receive from the people responses regarding the goals and/or expectations of the enterprise. The user 156 may then provide input to the opportunity evaluation system 150 regarding the responses and/or an analysis of the responses carried out by the user 156. For example, the user 156 may input the explicit responses received from the people and/or may input information derived from the responses by the user 156, such as an average, summary, or other combination of the responses from the people. The opportunity evaluation system 150, upon receiving the information, may store the information in the data store 153.

In some embodiments, information regarding the enterprise may additionally or alternatively be computed by the opportunity evaluation system 150. As shown in FIG. 1, the enterprise environment 112 includes multiple users 160A, 160B, 160C (collectively referred to herein as the users 160) each of whom is a person affiliated with the enterprise. The people affiliated with an enterprise may include stakeholders of the enterprise. The people may be, for example, officers, directors, investors, managers, or employees of the enterprise, or any other person who is familiar with the enterprise and/or the goals of the enterprise. In some cases, the people affiliated with an enterprise may include customers of the enterprise and/or experts who have been hired to consult for the enterprise in connection with developing an investment strategy for the enterprise or in connection with any other matter. In some cases, the users 160 may be identified to the opportunity evaluation system 150 by the user 156, via the computing device 154. Once the users 160 are identified to the opportunity evaluation system 150, the opportunity evaluation system 150 may survey the users 160 regarding the goals and/or expectations of the enterprise.

In embodiments in which the system 150 surveys users 160, the opportunity evaluation system 150 may survey the users 160 in any suitable manner, as embodiments are not limited in this respect. In the example of FIG. 1, the opportunity evaluation system 150 may present one or more questions to the users 160 via a user interface. For example, the users 160 may each operate a computing device 162A, 162B, 162C (collectively referred to herein as computing devices 162). The opportunity evaluation system 150 may display on the devices 162 an interface including questions for the users 160. The interface may be any suitable interface, including a web page interface, as embodiments are not limited in this respect. The users 160 may be asked the same or different questions in the interface, and the questions may include questions related to goals and/or expectations of the enterprise as perceived by the users 160. The users 160 may provide responses to the questions via the devices 162 and the devices 162 may convey the responses to the opportunity evaluation system 150. Upon receipt of the responses from the users 160, the opportunity evaluation system 150 may compute the goals and/or expectations of the enterprise and store the result(s) of the computations in the data store 153. Examples of ways in which the system 150 may query stakeholders and evaluate responses from stakeholders to determine goals and/or expectations of an enterprise are described in detail below.

As mentioned above, the opportunity evaluation system may be configured with any suitable information regarding an enterprise and may use this information to evaluate investment opportunities. In some embodiments, the information regarding the enterprise may include one or more goals of the enterprise and may include one or more capability deficits for the enterprise. The capability deficits for the enterprise may represent potential classifications for investment opportunities that are to be evaluated by the opportunity evaluation system. In some embodiments, the information regarding the enterprise may additionally include, for each capability (or capabilities) deficit, an estimate of an impact that investments, in general, that are classified in the capability deficit will have in assisting the enterprise in achieving one or more particular goals or the goal(s) of the enterprise in general. The estimate may be a numeric value that was input by the user 156 or may be a numeric value computed by the system 150 based at least in part on responses from the users 160. The opportunity evaluation system may use the information, including, in some embodiments, the estimates, to score investment opportunities for the enterprise.

FIG. 1 illustrates a production environment 114 that includes a user 170 that operates a computing device 172. The computing device 172 may have an interface by which the user 170 may provide input regarding investment opportunities. The user 170 may input any suitable information regarding an investment opportunity, as embodiments are not limited in this respect. In some embodiments, the user 170 may provide input regarding an investment opportunity, which may include information regarding a classification of the investment opportunity. The classification of an investment opportunity may be an identification of one or more capability deficits to which the investment opportunity relates, out of the capability deficits identified for the enterprise with which the opportunity evaluation system 150 is configured. The user 170 may also input one or more other characteristics of an investment opportunity. The characteristics of the investment opportunity may be information describing the investment opportunity or an expected result of the investment opportunity. Examples of characteristics of an investment opportunity include an estimated financial return on the investment opportunity, an anticipated time to success for the investment, an anticipated risk associated with the investment or any other suitable information regarding the potential impact of the investment opportunity on the enterprise.

Incoming deal flow 180 represents investment opportunities that may be evaluated by the opportunity evaluation system 150. Based on information regarding investment opportunities of the flow 180 that is input by the user 170, the opportunity evaluation system 150 may identify which (if any) of the investment opportunities in the flow 180 potentially present value to the enterprise and should be considered in more detail for investment. The opportunity evaluation system 150 may, through this process, determine that only a portion of the investment opportunities included in the flow 180 appear to be viable investments for the enterprise, in that only some of the investment opportunities may be estimated to have a high impact in assisting the enterprise achieve its goal(s). Accordingly, following evaluation by the opportunity evaluation system 150, there may be fewer investment opportunities for the enterprise to consider, as represented by the smaller processed deal flow 182.

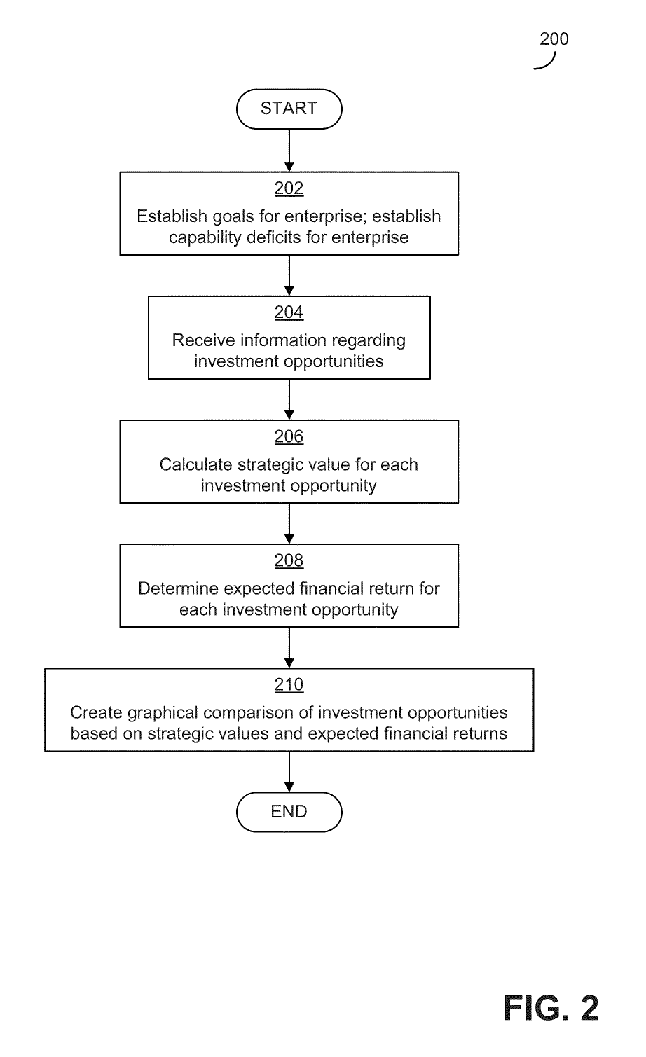

An opportunity evaluation system may evaluate an investment opportunity in any suitable manner to determine a value that the investment opportunity presents to an enterprise. FIG. 2 illustrates an example of a way in which an opportunity evaluation system may evaluate investment opportunities.

The process 200 of FIG. 2 begins in block 202, in which the opportunity evaluation system establishes goals for an enterprise and establishes capability deficits for the enterprise.

The goals of the enterprise may be any suitable objective for an enterprise, including strategic objectives that will aid an enterprise in achieving a purpose of the enterprise, as embodiments are not limited in this respect. In some embodiments, a goal may be a commercial goal. Commercial goals may include goals related to sales of goods and/or services, such as increasing an amount of goods and services sold in a time period, expanding sales to new geographic and/or demographic markets, or increasing profit margins on sales. Commercial goals may also include goals related to purchase of goods and/or services, such as decreasing amounts spent by the enterprise on acquiring the goods and/or services. Goals of an enterprise may additionally or alternatively include organizational goals. Organizational goals may include goals related to a manner in which the enterprise operates. Reducing turnover, increasing operational efficiency or decreasing waste of resources, and decreasing a timeline for spawning new goods or services are examples of organizational goals. Goals of an enterprise may additionally or alternatively include industry structure goals, market influence goals, asset management or allocation goals, or any other goals deemed useful by the enterprise and that may assist the enterprise in achieving one or more purposes of the enterprise.

Capability deficits for an enterprise, as discussed above, are Capabilities that the enterprise does not current possess, that the enterprise possesses but which are deemed to be at risk of being inadequate to future needs of the enterprise, and/or that the enterprise will not soon possess. In some embodiments, to evaluate investment opportunities, the investment opportunities may be identified as related to one or more capability deficits. In some embodiments, the investment opportunities may be categorized according to the capability deficits, and the capability deficits may be considered categories by which the investment opportunities may be categorized. The capability deficits may be related to investment opportunities in any suitable manner, as embodiments are not limited in this respect. In some embodiments, the capability deficits may each relate to one or more characteristics of investment opportunities, such that each investment opportunity is classified according to one or more characteristics of the investment opportunity. For example, in cases when some or all investment opportunities may be expected to produce innovations, some or all of the capability deficits may be related to types of innovations. A type of innovation may be related, for example, to a result made possible by an innovation or a means by which the innovation operates to produce a result. In some cases, a type of innovation may be related to a field of technology to which the innovation relates. Thus, in some embodiments, an investment opportunity that is expected to yield an innovation may be classified according to a result that the innovation produces, a way in which the innovation operates, and/or a technological field to which the innovation relates.

The opportunity evaluation system may establish the goals and capability deficits in block 202 in any suitable manner, examples of which are described below. In some embodiments, the opportunity evaluation system may establish the goals and capability deficits based on evaluating input provided by people affiliated with the enterprise. For example, the opportunity evaluation system may receive from multiple people a set of one or more goals for the enterprise. By evaluating the set of goals received from each of the multiple people, the opportunity evaluation system may identify a single set of goals for the enterprise. For example, the opportunity evaluation system may identify the goals that appear most often on the sets provided by the stakeholders as the goals of the single set. Other examples of ways in which the goals may be identified are discussed below.

The opportunity evaluation system may also, in some embodiments, identify the capability deficits based on input provided by people affiliated with the enterprise. For example, multiple people may provide input regarding characteristics of investment opportunities that are estimated to have an impact in assisting the enterprise in achieving the enterprise's goals. The people may, for example, be asked to identify an importance of a characteristic of investment opportunities to achieving the goals of the enterprise. The people may also be asked to estimate a likelihood that investment opportunities having the characteristic will be available to the enterprise. In the case that a characteristic of an investment opportunity relates to a field of technology for an innovation that is expected to be produced by an investment opportunity, the questions may relate to an importance of the field of technology to the enterprise and an estimate that there will be innovation in the field of technology. Based on the response of the stakeholders to the questions, the opportunity evaluation system may identify capability deficits and, for each capability deficit, an estimate of an impact that investments that are categorized in the capability deficit will have, in general, in assisting the enterprise achieve the goals of the enterprise. Other examples of ways in which the capability deficits may be identified are discussed below.

The goals and the capability deficits may be established by the opportunity evaluation system in block 202 during an initialization phase of the opportunity evaluation system. During the initialization phase, the opportunity evaluation is configured (including by configuring itself, in embodiments in which the opportunity evaluation system processes input to establish the goals and deficits) with information regarding the enterprise. Once configured with information regarding the enterprise, the opportunity evaluation system may evaluate investment opportunities in accordance with that information to determine a value that an investment opportunity presents to the enterprise.

To evaluate investment opportunities, in block 204 the opportunity evaluation system receives information regarding one or more investment opportunities. The information may be received from any suitable source, such as one or more human users providing information via a web interface or other suitable electronic interface. When the opportunity evaluation system receives information regarding multiple investment opportunities, the system may receive the information regarding different investment opportunities at different times or may receive the information for the multiple investment opportunities all at once, as embodiments are not limited in this respect. For example, in some embodiments in which the investment system receives information regarding multiple investment opportunities, the system may produce an output regarding one investment opportunity, based on information received regarding the investment opportunity, before receiving information regarding another investment opportunity. As another example, a human user may input information regarding multiple investment opportunities together, as a batch, to the opportunity evaluation system. As yet another example, the system may receive information electronically from another system about an investment opportunity or batch of investment opportunities.

The information regarding an investment opportunity that is received in block 204 may include any suitable information regarding characteristics of an investment opportunity. For example, the information regarding an investment opportunity may include information on an estimated financial return of the investment opportunity. In some embodiments, the information regarding the investment opportunity may also include information regarding a classification of the investment opportunity according to the capability deficits for the enterprise. An investment opportunity may be classified into one, two, or more capability deficits, based on characteristics of the investment opportunity and characteristics to which the capability deficits relate. As discussed above, for example, an investment opportunity may be categorized according to a type of innovation that the investment opportunity is expected to yield.

In some embodiments, the information regarding the classification of the investment opportunity may include information identifying the one or more capability deficits into which the investment opportunity is classified. In other embodiments, the information regarding the classification may additionally include information regarding an estimate of an amount by which the investment opportunity will assist the enterprise in achieving the enterprise's goals. The estimated amount may be related to a capability deficit, and when an investment opportunity is classified according to multiple capability deficits, the system may receive an estimated amount for each capability deficit. For example, in cases where capability deficits are related to types of innovation, the estimated amounts for an investment opportunity may be estimated amounts by which innovations resulting from the investment opportunity will assist the enterprise in meeting the goals. More particularly, when the investment opportunity is classified into multiple capability deficits due to multiple innovations that are expected to result from the opportunity, the estimated amounts received as input in block 204 may be estimated amounts related to each of the capability deficits and, thereby, each of the innovations. The estimated amounts may be estimates of an impact each innovation will have in assisting the enterprise achieve the goals. The estimated amounts may be expressed in any suitable manner, as embodiments are not limited in this respect. In some embodiments, the estimated amounts may be expressed as percentages indicating a percentage of the progress toward one or more of the enterprise's goals that the innovation is expected to provide (e.g., advance the enterprise 70% of the way toward achieving one or more goals, or all goals of the enterprise, established in block 202). In some embodiments the estimated amounts may be expressed as the level of fit between the innovation and a capabilities deficit using any suitable scoring schema or other system of articulation which differentiates between degrees of fitness.

The opportunity evaluation system may store the information regarding the investment opportunities following receipt of the information in block 204.

In block 206, the opportunity evaluation system calculates a strategic value for each investment opportunity. The strategic value of an investment opportunity may indicate a strategic value that the investment opportunity presents to the enterprise in terms of assisting the enterprise with achieving the goals established in block 202. The opportunity evaluation system may calculate the strategic value in any suitable manner, examples of techniques for which are described below. In some embodiments, for example, the opportunity evaluation system may retrieve a classification of an investment opportunity from storage and calculate the strategic value of an investment opportunity based on the capability deficits into which the investment opportunity is classified. As discussed above, each capability deficit may be associated with a numeric value that represents an estimate of an impact that investments, in general, in the capability deficit will have in assisting the enterprise to achieve the goals established in block 202. In some embodiments, when an investment opportunity is classified into one or more capability deficits, some or all of the numeric estimates associated with those capability deficits may be used to calculate a strategic value of the investment opportunity. In embodiments in which the classification of the investment opportunity includes one or more estimates of amount(s) by which the investment opportunity will assist the enterprise in achieving the enterprise's goals, the opportunity evaluation system may calculate the strategic value based on the estimates.

In block 208, the opportunity evaluation system determines an estimated financial return for each investment opportunity. The opportunity evaluation system may determine the estimated financial return in any suitable manner. In some embodiments, the estimated financial return may be input to the opportunity evaluation system in block 204. In these embodiments, determining the estimated financial return may include retrieving the estimated financial return from storage. In other embodiments, the estimated financial return may be computed by the opportunity evaluation system from multiple inputs provided in block 204. For example, in some embodiments a user may input in block 204 information regarding an investment return for the investment opportunity, which represents the financial return that can be expected merely from the investment. The investment return may be based on the terms of the investment. The user may additionally input in block 204 consequential return that may represent a monetary gain that the enterprise is expected to realize from advantage gained by utilizing the innovations associated with the investment opportunity, if the investment opportunity is successful in achieving an innovation objective of the opportunity. The consequential return may be based on a type of the investment opportunity and an objective of the investment opportunity. For example, if the investment opportunity relates to an organization that is seeking to develop a technological innovation, the consequential result may be a monetary amount that the enterprise is expected to realize from taking advantage of the technological innovation, if the organization is successful in developing the innovation. In some embodiments, the estimated financial return may be computed by the opportunity evaluation system based on both the investment return and the consequential return. For example, the system may sum the investment return and the consequential return to determine the estimated financial return.

In block 210, the opportunity evaluation system creates a graphical comparison of investment opportunities based on the calculated strategic values and estimated financial returns. The graphical comparison presents a graphical view of the investment opportunities that enables a user of the opportunity evaluation system to review the investment opportunities and view a comparison of the investment opportunities. The graphical comparison created in block 210 may be any suitable graphical comparison, as embodiments are not limited in this respect. In some embodiments, the graphical comparison may include graphical identifiers corresponding to each of the investment opportunities for which information has been received by the opportunity evaluation system, which may include the one or more investment opportunities for which information was received in block 204 as well as other investment opportunities for which information was previously received. By displaying the graphical identifiers for the investment opportunities, a user (e.g., user 170 of FIG. 1, operating computing device 172) may compare the investment opportunities, determine which investment opportunities present high value to the enterprise, and select investment opportunities that the enterprise should evaluate further.

In some embodiments, the opportunity evaluation system may create the graphical comparison in block 210 based at least in part on one or more thresholds regarding value of investment opportunities. The thresholds may be set in any suitable manner, including according to user input. For example, in some embodiments, the graphical comparison may include graphical elements that represent thresholds for strategic value and for estimated financial return. By including the graphical elements for the thresholds, a user may be able to determine quickly which investment opportunities exceed the thresholds and which investment opportunities may present good opportunities for investment by the enterprise. In other embodiments, however, the graphical comparison may not include graphical elements for the thresholds, and the system may instead use the thresholds in other manners. For example, in some embodiments, the opportunity evaluation system may evaluate the value of each investment opportunity using the one or more thresholds and determine, from the evaluation, which investment opportunities have a value exceeding the threshold(s). The opportunity evaluation system may then store an indication of which investment opportunities have values exceeding the threshold(s). The opportunity evaluation system may then, in block 210, create a graphical comparison that includes only those investment opportunities that have values exceeding the thresholds.

Once the opportunity evaluation system creates the graphical comparison in block 210, the graphical comparison may be stored in a storage medium by the system and the process 200 ends. Following the process 200, the graphical comparison may be output to a user (e.g., user 170 of FIG. 1), such as by displaying the graphical comparison to a user and/or transmitting the graphical comparison to a computing device for display to a user. Through the process 200, the opportunity evaluation system may compute a value that one or more investment opportunities presents to an enterprise and thereby assist an enterprise (e.g., one or more investors that invest on behalf of the enterprise) in selecting investment opportunities in which to invest.

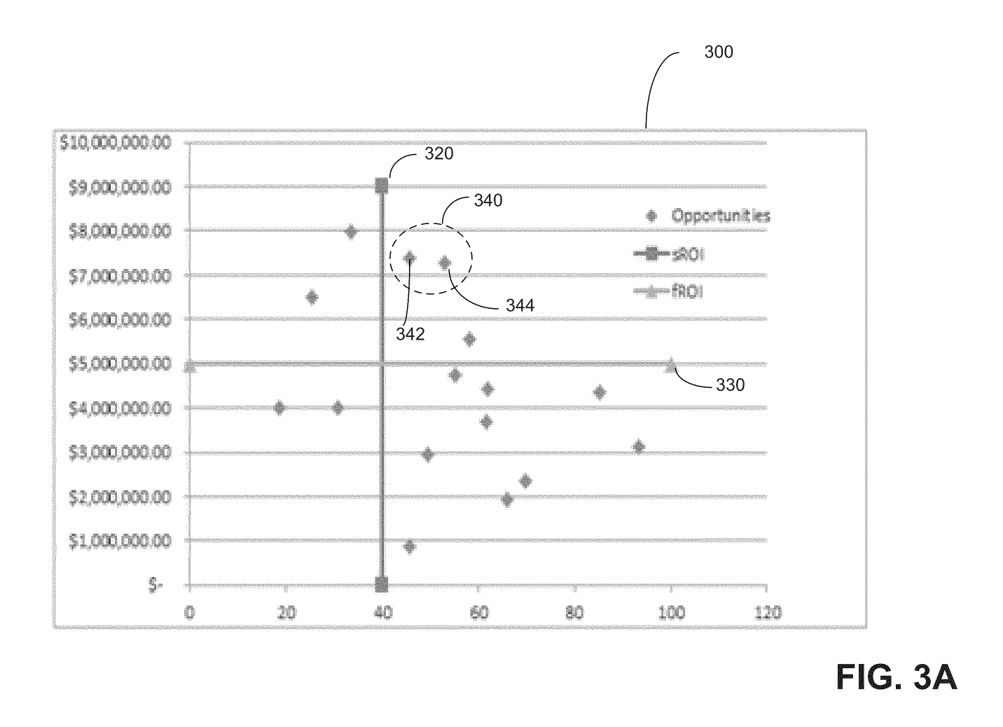

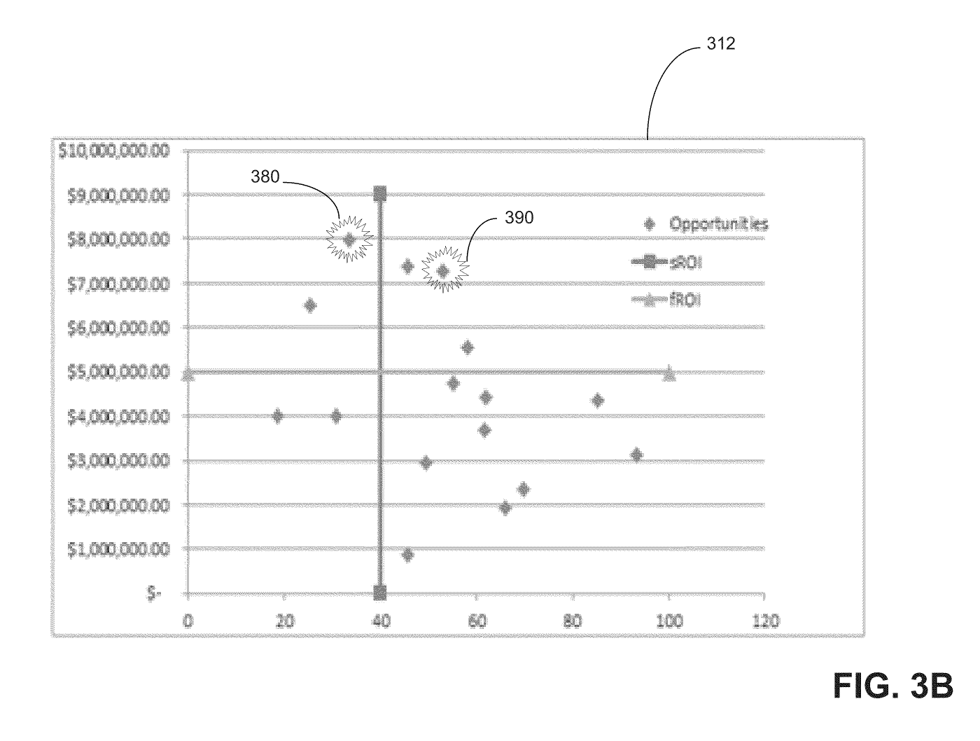

It should be appreciated that embodiments in which a graphical comparison of investment opportunities is created by an opportunity evaluation system are not limited to creating any particular graphical comparison. Any suitable graphical comparison may be created. FIGS. 3A and 3B illustrate an example of a graphical comparison that may be created by an opportunity evaluation system in some embodiments.

In some embodiments, a graphical comparison created by the opportunity evaluation system may be a graph illustrating a coordinate system having two or more dimensions. Each of the dimensions of the coordinate system may relate to characteristics of an investment opportunity, or of conditions of the enterprise, or of constituent elements of the total information regarding the condition of the enterprise, or of the investment opportunity, or of market conditions, or of any other suitable data. The characteristics may include characteristics of an investment opportunity input to the system by one or more users or computed by the system based on input provided by one or more users.

In the example of FIG. 3A, the graphical comparison 300 is a graph of a coordinate system having two dimensions. A first dimension of the coordinate system, shown as the Y-axis in the graphical comparison 300, relates to an estimated financial return of an investment opportunity, which is expressed in dollars. The second dimension of the coordinate system, shown as the X-axis in the graphical comparison 300, relates to a strategic value that an investment opportunity presents to an enterprise. In the example of FIG. 3A, the strategic value of an investment opportunity may be a scalar value indicating an estimate of an impact that the investment opportunity may have in assisting the enterprise achieve one or more (or all) of the enterprise's goals. As discussed briefly above and in more detail below, in some embodiments this estimate of an impact of an investment opportunity may be computed by the opportunity evaluation system based at least in part on a classification of the investment opportunity.

The graphical comparison 300 includes graphical identifiers for each of the investment opportunities that have been evaluated by the opportunity evaluation system during a time period. Graphical identifiers 342 and 344 each correspond to a different investment opportunity. The graphical identifiers 342, 344 are placed at locations in the graph corresponding to the estimated financial return and strategic value determined for the investment opportunities.

The graphical comparison 300 also includes graphical elements corresponding to thresholds for investment opportunities. Displaying graphical elements corresponding to the thresholds may assist users that view the graphical comparison 300 in quickly determining which investment opportunities present sufficiently high value to the enterprise to be considered in more detail for investment. Graphical element 320 represents a threshold value for strategic values computed for investment opportunities, which represents a desired minimum strategic value for investment opportunities that are to be considered in more detail for investment. The threshold may be set in any suitable manner, including according to user input. In some embodiments, graphical identifiers for investment opportunities for which computed strategic values are below the threshold are displayed in the graphical comparison, such that users may still evaluate such investment opportunities if they desire. Graphical element 320 may therefore serve, in some embodiments, merely as a guide for users in selecting investment opportunities to consider in more detail. Similarly, graphical element 330 represents a threshold value for estimated financial return of investment opportunities.

In some embodiments, investment opportunities having values that exceed all thresholds set for the coordinate system (e.g., both thresholds in a two-dimensional coordinate system) may be highlighted to a user in the graphical comparison 300, such that the user may quickly identify the investment opportunities that should be further evaluated. For example, a highlighting graphical element 340, shown in FIG. 3A as a circle surrounding identifiers for investment opportunities that exceed the thresholds, may be included in the graphical comparison.

In some embodiments, a graphical comparison of the type illustrated in FIG. 3A may identify the investment opportunities that exceed the threshold(s) and all of these investment opportunities may be selected for further investigation (e.g., due diligence) or for investment. In some such cases, the opportunity evaluation system may automatically select for further investigation the investment opportunities that exceed the thresholds and communicate to one or more users or computer-based services that investments are may be made in the selected opportunities. In other embodiments, however, users may review the graphical comparison and use the graphical comparison to aid the user in selecting investment opportunities in which the enterprise is to invest. For example, a user may review investment opportunities that fall above and below thresholds and may select investments that fall below one or more thresholds and not select investments that exceed one or more thresholds.

FIG. 3B illustrates a graphical comparison 312 that corresponds to the graphical comparison 300 of FIG. 3A. Two graphical identifiers 380, 390 for investment opportunities are highlighted in FIG. 3B. The graphical identifier 380 represents an investment opportunity for which the opportunity evaluation system computed a strategic value that falls below the threshold. The investment opportunity corresponding to the identifier 380, however, has a higher estimated financial return than any other investment opportunity for which information is displayed in the comparison 312. In some cases, an enterprise may select the investment opportunity corresponding to identifier 380 for further review, and may select the investment opportunity for investment, based on the high estimated financial return. The enterprise may do so even though the investment opportunity was not determined by the system to present a high strategic value.

As discussed in more detail below, an investment opportunity may be related to one or more capability deficits and a strategic value that an investment opportunity presents to an enterprise may be calculated based on those capability deficits. In some embodiments, the strategic value may be calculated as an average of values for each of the capability deficits. In general, averages of values can mask outliers, which are values that are higher than others included in the average. In some embodiments, as discussed below, the system may determine values for each of the capability deficits, and one or more of these values may be higher than others but may be masked by an average of the values. In some such embodiments, the system may be adapted to review the individual values for each of the capability deficits to which an investment opportunity relates (e.g., the capability deficits into which the investment opportunity is categorized) and may identify when one or more of the values for a particular capability deficit is higher than others. A value that is higher than others may be a value that is above a threshold or more than a threshold amount above other values. In the INNOVATION CAPITAL™ system, opportunities that are selected for a high value related to one or more GAPPORTUNITIES™, despite a low overall strategic value, are termed “Golden Swans.”

Additionally, in some cases a user reviewing investment opportunities for which information is displayed in the graphical comparison 312 may not select for investigation some investment opportunities that are determined by the system to exceed the thresholds. For example, graphical identifier 390 is illustrated in FIG. 3B as corresponding to an investment opportunity for which an estimated financial return and a strategic value exceed the thresholds. However, it may be that despite the system having computed the investment opportunity to have a high strategic value, the investment opportunity may have characteristics that disqualify the opportunity for investigation. This may be because the opportunity evaluation system is configured with information regarding expectations of the enterprise and those expectations may deviate from reality over time. For example, the investment opportunity corresponding to identifier 390 may be determined to have a high strategic value because the opportunity is expected to yield an innovation that was, when the system was configured, expected to have a high impact in assisting the enterprise in achieving its goals. However, when the investment opportunity is reviewed by a user following creation of the graphical comparison 312, the user may be aware that the innovation is not going to have as great an impact as previously expected. Alternatively, when the investment opportunity is reviewed by the user, the user may be aware that the enterprise recently invested in another investment opportunity that is expected to yield a similar innovation, and thus this investment opportunity may be considered redundant. A third possibility is that the investment opportunity may have characteristics which create a conflict with trumps the potential for strategic value represented by the opportunity. In any case, despite that the system computed the investment opportunity to have a high strategic value, a user may determine that the investment opportunity is in actuality impaired in an ability to create strategic value to the enterprise. In the INNOVATION CAPITAL™ system, investment opportunities having calculated values that exceed thresholds but that actually present low value to the enterprise are termed “Black Swans.”

Accordingly, when a user reviews output of an opportunity evaluation system that was produced in accordance with techniques described herein, the user may use the output to inform a selection of investment opportunities, but may not fully follow recommendations of the system. The user may review investment opportunities to identify “Golden Swans” or “Black Swans” or review the investment opportunities in any other way to supplement the analysis carried out by the opportunity evaluation system.

Described below are various examples of ways in which an opportunity evaluation system may receive information regarding goals and expectations of an enterprise and process the input to determine the goals and expectations of the enterprise during an initialization period. Also described below are various examples of ways in which an opportunity evaluation system may use information regarding goals and expectations of an enterprise to evaluate investment opportunities for the enterprise. It should be appreciated that embodiments are not limited to operating in accordance with the examples below and that other embodiments are possible.

In some of the examples below terminology of the INNOVATION CAPITAL™ system is used, and techniques implemented by the INNOVATION CAPITAL™ system are described. As discussed above, however, it should be appreciated that embodiments are not limited to operating in accordance with the INNOVATION CAPITAL™ system.

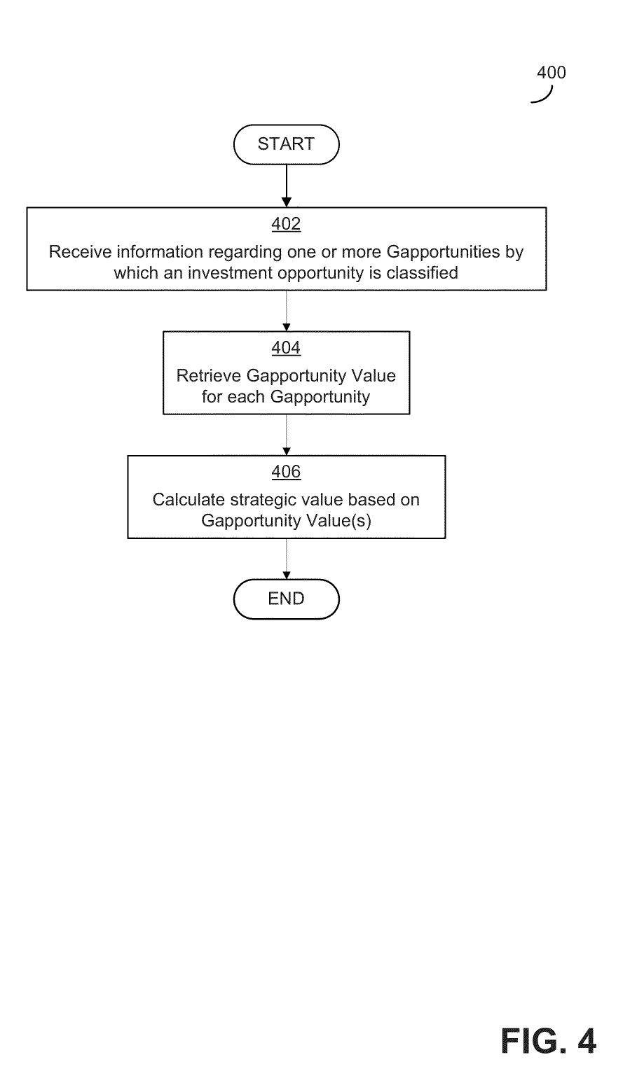

FIG. 4 illustrates a process 400 that may be implemented by an opportunity evaluation system in some embodiments for determining a strategic value that an investment opportunity presents to an enterprise. The process 400 may be carried out by an opportunity evaluation system during a production phase of the system, following an initialization phase. Accordingly, prior to the start of the process 400 of FIG. 4, the opportunity evaluation system may be configured with information regarding the goals and expectations of an enterprise. The information with which the system is configured may include information on capability deficits of the enterprise and estimates of an impact that investments, in general, in the capability deficit will have in assisting the enterprise in achieving one or more goals of the enterprise. As mentioned above, in the INNOVATION CAPITAL™ system, a capability deficit is termed a GAPPORTUNITY™ and the estimate is termed a GAPPORTUNITY™ Value.

The process 400 begins in block 402, in which the system receives information regarding one or more GAPPORTUNITIES™ by which an investment opportunity is classified. As discussed above, an investment opportunity may be classified according to a GAPPORTUNITY™ when the investment opportunity has a characteristic to which the GAPPORTUNITY™ relates. In some embodiments, a GAPPORTUNITY™ may relate to a type of innovation. In these embodiments, the investment opportunity may be classified in the GAPPORTUNITY™ when the investment is expected to yield an innovation of the type to which the GAPPORTUNITY™ corresponds.

In block 404, the system retrieves from one or more storage media a GAPPORTUNITY™ Value for one, some, or all of the GAPPORTUNITIES™ into which the investment opportunity is classified.

In block 406, the system calculates a strategic value for the investment opportunity based on the GAPPORTUNITY™ Values retrieved in block 404. The system may calculate the strategic value in any suitable manner, as embodiments are not limited in this respect. In some embodiments, the system may calculate the strategic value as the highest or lowest of the GAPPORTUNITY™ Values. In other embodiments, the system may calculate the strategic values as an average of the GAPPORTUNITY™ Values or a sum of the GAPPORTUNITY™ values. Any suitable calculation may be used. Examples of other ways in which an opportunity evaluation system may calculate a strategic value of an investment opportunity are described below.

Once the system calculates the strategic value in block 406, the strategic value may be stored in one or more storage media and the process 400 ends. As a result of the process 400, the opportunity evaluation system stores a numeric value that relates to a strategic value that an investment opportunity presents to the enterprise. The strategic value may then be evaluated to determine whether an investment opportunity is a potentially good investment and warrants further consideration by the enterprise or may be evaluated in any other suitable manner.

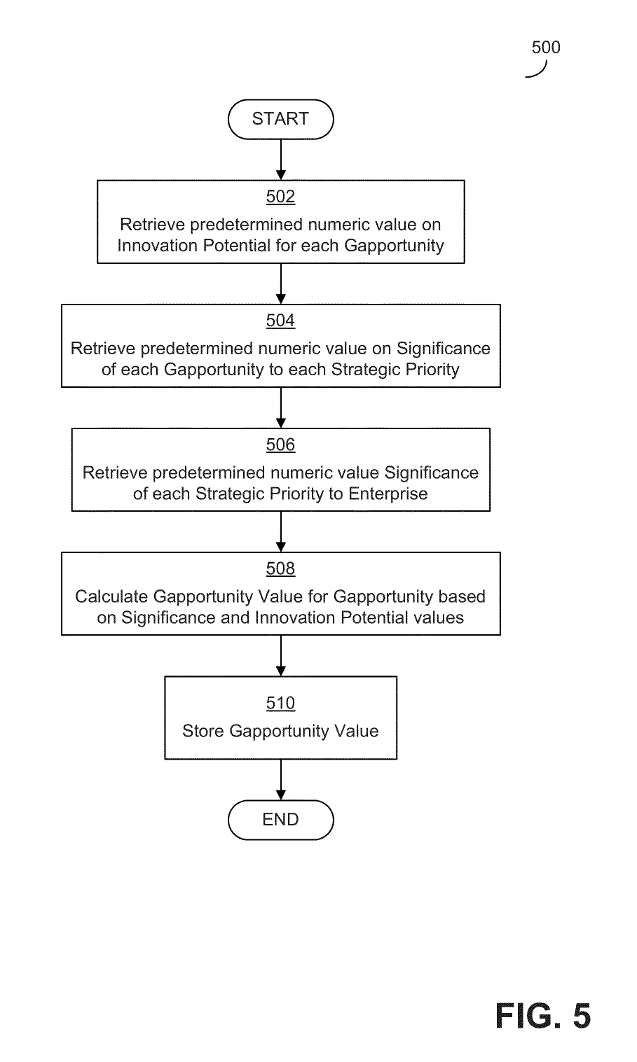

Prior to the start of the process 400, the opportunity evaluation system is configured with information regarding the goals and/or expectations of the enterprise. The system may be configured with the information in any suitable manner, as embodiments are not limited in this respect. Various techniques for configuring an opportunity evaluation system are described in connection with FIGS. 5-9 below.

FIG. 5 illustrates an example of a process that may be carried out by an opportunity evaluation system during an initialization phase to determine, for a capability deficit, an estimate of an impact that investments in opportunities classified in the capability deficit, in general, will have in assisting (including hindering) the enterprise in achieving one, some, or all of its goals. As mentioned above, in the INNOVATION CAPITAL™ system, a capability deficit for an enterprise is termed a GAPPORTUNITY™ and the estimate is termed a GAPPORTUNITY™ Value.

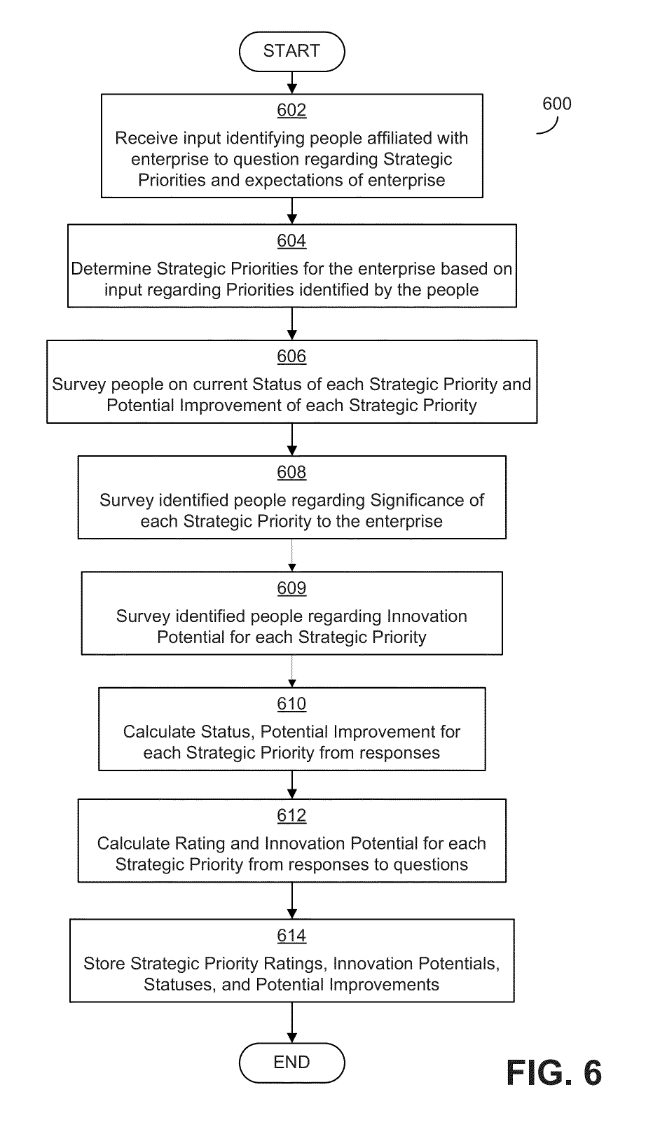

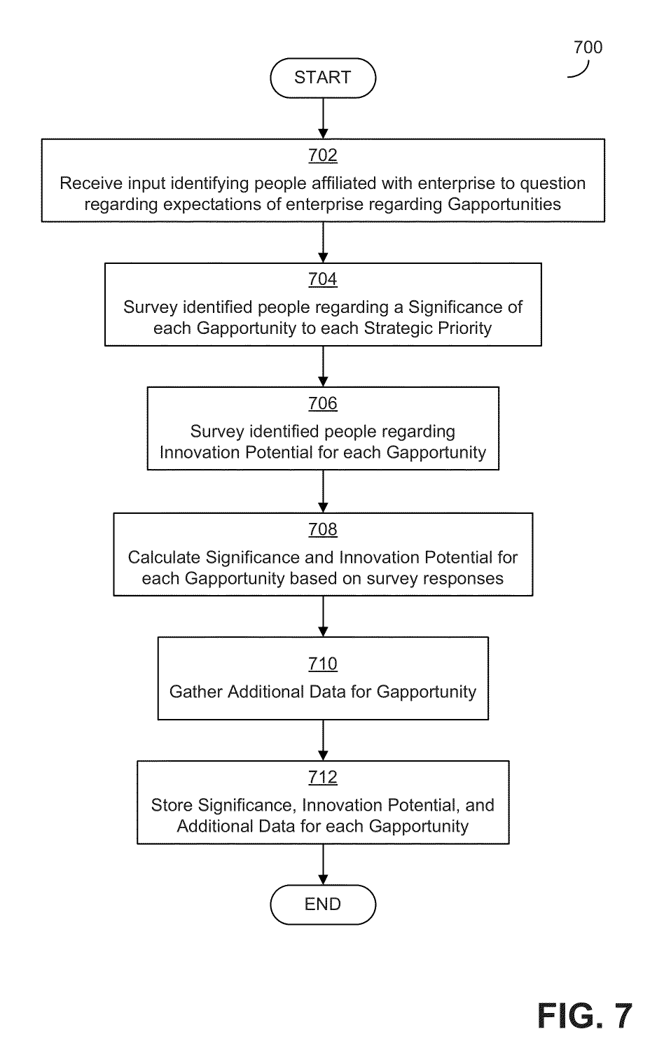

Prior to the start of the process 500 of FIG. 5, the opportunity evaluation system may compute numeric values for a Significance and Innovation Potential for each GAPPORTUNITY™, and may compute a Significance for each Strategic priority. Once computed, these values may be stored in a storage medium. The opportunity evaluation system may compute the values in any suitable manner and based on any suitable input. Examples of the ways in which the Significance values and Innovation Potential values may be computed by the system are described below in connection with FIGS. 6-7.

The process 500 begins in block 502, in which the opportunity evaluation system retrieves from one or more storage media a value for each GAPPORTUNITY™ that indicates an Innovation Potential for the GAPPORTUNITY™. The Innovation Potential for a GAPPORTUNITY™ may be a percentage value, or any other suitable numeric value. The Innovation Potential may be an expectation of the enterprise. The Innovation Potential indicates an expected likelihood that there will be an innovation in a GAPPORTUNITY™. As discussed above, a GAPPORTUNITY™ is a capability deficit into which investment opportunities may be classified. A capability deficit, as discussed above, may relate to any suitable characteristic of an investment opportunity including, in some embodiments, a type of innovation that may result from the investment opportunity. Thus, in some embodiments, a GAPPORTUNITY™ may relate to a type of innovation, and an Innovation Potential for the GAPPORTUNITY™ may represent an estimate by the enterprise of an amount of improvement in innovation expected in the related type of innovation and/or a likelihood that innovations of the related type will be created.

In block 504, the opportunity evaluation system retrieves from one or more storage media a value for each GAPPORTUNITY™ that indicates a Significance of the GAPPORTUNITY™ to each Strategic Priority. As discussed above, each Strategic Priority may be a goal of the enterprise and a GAPPORTUNITY™ is a capability deficit for the enterprise. A “Significance” of a capability deficit to a goal represents an expected importance that, in general, investments that are classified in the capability deficit will have in assisting (including hindering) the enterprise in achieving that goal of the enterprise. An expected importance of a capability deficit in assisting the enterprise achieve a goal may be an expected amount of impact that investments classified in the capability deficit will have in assisting the enterprise achieve the goal. An expected impact may be described as a “high/low” and “large/small” impact (or other suitable qualitative indication of impact), or may be described on a scale of 1-10 (or any other suitable numeric scale), or may be described in any other manner. Accordingly, using the INNOVATION CAPITAL™ terminology, a “Significance” of a GAPPORTUNITY™ to a Strategic Priority represents an expected amount of impact that investment opportunities categorized in the GAPPORTUNITY™ will have in assisting the enterprise in achieving the Strategic Priority.

An expected importance value for a GAPPORTUNITY™ and a goal may have a positive or negative value. A positive value may represent that investment opportunities classified in the GAPPORTUNITY™ may help the enterprise achieve that goal, while a negative value may represent that investment opportunities classified in the GAPPORTUNITY™ may hinder the enterprise in achieving that goal. In block 504, the system may retrieve one or more Significance values for one or more GAPPORTUNITIES™, where each Significance value for corresponds to a GAPPORTUNITY™ and to a Strategic Priority. In some cases, the system may retrieve a Significance value for each combination of GAPPORTUNITY™ and Strategic Priority, though in other embodiments there may be pairs of GAPPORTUNITY™ and Strategic Priority for which Significance values have not be computed.

In block 506, the system retrieves from one or more storage media a value representing a Significance of each Strategic Priority to the enterprise. A Significance of a Strategic Priority may indicate an expected importance of a goal to the enterprise. In some embodiments, importance of goals may be set independently, such that each goal may have a value indicating an importance of that goal, by itself, to the enterprise. In other embodiments, importance of goals may be set relatively, such as by ranking the goals or otherwise indicating an importance of goals with respect to one or more others of the goals. An importance of a goal to the enterprise may be described in any suitable manner, including “high” or “low” (or other suitable qualitative indication of importance) or a value on a scale of 1-10 (or other suitable numeric scale).

In block 508, once the values for the Significance and Innovation Potential of each GAPPORTUNITY™ are retrieved and the values for the Significance of the Strategic Priorities are retrieved, the system may calculate a GAPPORTUNITY™ Value for each GAPPORTUNITY™ based on these values. The system may calculate the GAPPORTUNITY™ Value in any suitable manner, as embodiments are not limited in this respect. In some embodiments, the system may calculate the Value by use of a weighting function. For example, the Value may be calculated by multiplying each Significance value for a GAPPORTUNITY™ (which relates to the GAPPORTUNITY™ and to a Strategic Priority, as discussed above) by the Significance of the Strategic Priority to which the GAPPORTUNITY™ Significance value corresponds, and summing these products. Following the summing of the product of each pair of corresponding Significance values, the resulting sum may be multiplied by the Innovation Potential value for the GAPPORTUNITY™. In cases where one or more of the Significance or Innovation Potential values are qualitative values, and not quantitative, in block 508 these qualitative values may be exchanged for quantitative values. For example, when “low,” “medium,” and “high” descriptions are used for one of these values, those descriptions may be exchanged for numeric values like 1, 2, and 3 or any other suitable value. By exchanging the qualitative values for quantitative, the values may be used in an arithmetic equation.

Thus, an estimated impact that investments in a capability deficit may have in assisting the enterprise achieve one, some, or all of its goals (i.e., “a GAPPORTUNITY™ Value”) may be calculated based on an expected likelihood of innovation in the capability deficit, expected impacts that, in general, investments will have in assisting the enterprise in achieving each goal of the enterprise, and an importance of each goal to the enterprise.

In block 510, once the GAPPORTUNITY™ Value is calculated by the system for each GAPPORTUNITY™, the Value is stored in one or more storage media. Following storage of the Value in block 510, the process 500 ends. As a result of the process 500, the opportunity evaluation system has stored, for each capability deficit, the estimated impact that investments in a capability deficit, in general, may have in assisting the enterprise achieve one, some, or all of the enterprise's goals. These values may be used by the system to calculate a value that an investment opportunity presents to the enterprise, including a strategic value that the investment opportunity presents to the enterprise.

It should be appreciated that embodiments are not limited to calculating the estimated impact (“GAPPORTUNITY™ Value”) in the manner described above in connection with FIG. 5. Embodiments may calculate this value in any suitable manner. For example, in some embodiments, the estimated impact for a capability deficit may be determined by the opportunity evaluation system based on expected importance values (“Significance” values) that correspond to the capability deficit and to each of the goals of the enterprise. In some such embodiments, the estimated impact for a capability deficit may be calculated by the system as an average of these expected importance values. In other embodiments, the expected importance values for a capability deficit may be used together with likelihood of innovation values for a capability deficit, without using values regarding an importance of each of the goals. In still other embodiments, the expected importance values for a capability deficit may be used together with values regarding an importance of each of the goals, without using values regarding a likelihood of innovation. Embodiments are not limited to calculating the estimated impact values in any particular way.

In some embodiments, for example, the opportunity evaluation system may be configurable to operate in multiple modes with varying complexity of operations. In a “complex” mode, for example, the system may carry out the process 500 of FIG. 5, while in a “simple” mode, the system may carry out a modified version of the process 500, which may exclude blocks 502 and 506 and in which a GAPPORTUNITY™ Value is calculated in block 508 based only on one or more Significance values for the GAPPORTUNITY™ and one or more Priorities. A “medium” mode may include some or all of the procedures described in connection with FIG. 5 and may omit any suitable combination of procedures. For example, in a “medium” mode, the system may carry out a process that omits block 502 and calculates the GAPPORTUNITY™ Value based only on Strategic Priority Ratings and Significance values for the GAPPORTUNITY™. In embodiments in which the system is configurable to operate in different modes, the system may be configurable according to user input, and a user may select a mode in which the system is to operate.

In some embodiments, the opportunity evaluation system may collect information from people affiliated with an enterprise during an initialization phase, as part of determining goals and expectations of the enterprise that the system may use to score investment opportunities. FIGS. 6-8 illustrate examples of techniques that may be used in embodiments to collect information from people affiliated with an enterprise.

FIG. 6 illustrates a process 600 that may be implemented in some embodiments for questioning people regarding one or more goals of an enterprise. As discussed above, the goals of an enterprise may include any suitable objective of the enterprise, including strategic objectives. Strategic objectives may include any objectives related to the advancement of a purpose of the enterprise. Examples of goals include commercial goals and organizational goals. It should be appreciated, however, that embodiments are not limited to operating with any particular type or types of goals.

The process 600 begins in block 602, in which the opportunity evaluation system receives input identifying people affiliated with the enterprise. The people who are identified are people that are to be surveyed regarding goals of the enterprise and expectations of the enterprise regarding those goals. As mentioned above, in the terminology of the INNOVATION CAPITAL™ system, the goals of an enterprise are the Strategic Priorities of the enterprise. The people may be any suitable people, as embodiments are not limited in this respect. In some cases, the people identified in block 602 may include leaders of the enterprise who set the enterprise's direction and strategy. Such leaders may include senior-level executives of an enterprise, such as corporate officers or corporate directors in the case of a corporation. In some cases, people other than leaders may be identified. For example, in some cases, in addition to or as an alternative to leaders, workers of an enterprise, such as mid-level managers or employees (including unpaid employees or volunteers) of an enterprise may be identified. Identifying people other than leaders to survey about the Strategic Priorities of the enterprise may be advantageous in some cases, as it may provide a more comprehensive view of what people affiliated with the enterprise consider the Strategic Priorities of the enterprise.

In block 604, the opportunity evaluation system determines the Strategic Priorities of the enterprise based on input regarding Priorities identified by the people. The opportunity evaluation system may determine the Strategic Priorities in any suitable manner. In some embodiments, the opportunity evaluation system may determine the Strategic Priorities by accepting input, from a user, of a single set of Strategic Priorities that were determined collectively by the people. In other embodiments, the opportunity evaluation system may receive different sets of Strategic Priorities that were identified by the different people and the system may determine a single set of Strategic Priorities from the different sets. In such embodiments, the system may determine the single set based on the different sets in any suitable manner, as embodiments are not limited in this respect. For example, in some embodiments, the system may analyze the different sets of Priorities and identify Priorities that frequently appear between the different sets. As another example, in some embodiments the different sets of Strategic Priorities may each identify one or more Priorities and one or more Significances of the Priorities to the enterprise. In some such embodiments, the system may calculate, from the different sets, an overall Significance for each Priority and identify Priorities having the highest Significances.

In embodiments in which the opportunity evaluation system analyzes different sets of Strategic Priorities from different people to identify a set of Strategic Priorities for the Enterprise, the system may analyze all of the different sets in the same manner or may analyze sets from different people differently. For example, when input regarding Priorities is received from different groups of people affiliated with an enterprise, such as leaders and employees, the Priorities identified by people of one group (e.g., the leaders) may be given more weight in the analysis than the Priorities identified by people of another group (e.g., the employees). To give more weight to the Priorities identified by one group, the system may count Priorities identified by the one group more than Priorities identified by another group, such as by counting Priorities more than once when frequently-appearing Priorities are identified or by weighting Significances from one group higher than Significances from another when Significances are evaluated.

Once the Strategic Priorities are determined by the system in block 604, an identification of the set of Strategic Priorities is stored in one or more storage media by the system.

In blocks 606-609, once the Strategic Priorities are determined, the identified people may be surveyed regarding those Priorities. The people may be surveyed in any suitable manner. In some embodiments, the people may be surveyed by humans and the humans may input the responses from the people to the system. In other embodiments, the opportunity evaluation system may distribute surveys electronically, such as via one or more web pages, and the system may receive responses from the people electronically, via one or more computer communication networks.

In block 606, the people may be surveyed on a current Status of each Strategic Priority and a Potential Improvement that may be made to each Strategic Priority. The Status of a Priority indicates a current state of the Priority, as perceived by the person being surveyed. A current state may be described in any suitable manner, as embodiments are not limited in this respect. In some embodiments, a Status may be described in terms of progress toward achievement of the Priority, which may be expressed as a percentage or as a state in a workflow for the Priorities. In other embodiments, a Status may be described in terms of a rating of the enterprise's current efforts in this area, such as a numeric rating on a scale of 1-10 (or other suitable scale). A Potential Improvement is related to Status and represents the person's expectation of an amount of progress the enterprise can or will make with respect to the Priority. The Potential Improvement may be described in similar terms as the Status and may represent a target state that the person estimates the enterprise could achieve within a time period. The time period may be any suitable time, such as a quarter or year, as embodiments are not limited in this respect. For example, in a case where Status and Potential Improvement are represented as ratings of the enterprise's efforts regarding a Priority, a Status of a Priority may be given by a person as 5.5 out of 10 and a Potential Improvement of a Priority may be given by the person as 6.0 out of 10, where 10 out of 10 represents ideal performance with respect to the Priority. A Status of 5.5 indicates that the person believes the enterprise's current efforts are better than average, and the Potential Improvement of 6.0 indicates that the person expects that the enterprise will make only modest improvements to those efforts within a certain time period.

In block 608, the people may be surveyed on a Significance of each Strategic Priority to the enterprise. A Significance of a Priority may represent an expected importance of the Priority to the enterprise, as perceived by the person. The expected importance of each Priority may be set independent of other priorities, or may be set relative to the other priorities such as when the Priorities are ranked or otherwise compared. In some embodiments, the importance of each Priority may be indicated quantitatively, such as on a scale of 1-10 or any other numeric scale. In other embodiments, the importance of each Priority may be indicated qualitatively, such as using descriptions like “high” and “low.”

In block 609, the identified people are surveyed regarding an Innovation Potential for each Strategic Priority. An Innovation Potential for a Strategic Priority represents an expected likelihood that there will be an innovation that will assist the enterprise in achieving the Strategic Priority. The Innovation Potential received in block 609 represents a perception of the person at that time that there will be innovation that can assist the enterprise in achieving the Strategic Priority. The Innovation Potential may be represented in any suitable manner, including as a numeric value such as a percentage value or a value on a scale of 1-10 (or other suitable scale).

In blocks 610 and 612, the responses from each of the people received in response to the surveying of blocks 606-609 are evaluated. In block 610, the opportunity evaluation system calculates a Status and a Potential Improvement for each of the Strategic Priorities. In block 612, the opportunity evaluation system calculates a Rating for each Strategic Priority based on the Significance ratings provided by the people and an Innovation Potential for the Strategic Priority based on the Innovation Potential responses provided by the people. The system may calculate these values in any suitable manner. In some embodiments, the system may calculate the values as a mean, median, or mode of the responses received from the people. In some such embodiments, the responses from each of the people may be calculated in the same way, whereas in other embodiments responses from different groups of people may be weighted differently, similar to the procedure discussed above in block 604. The values for Status, Potential Improvement, Rating, and Innovation Potential calculated in blocks 610, 612 may be any suitable description of these values, such as qualitative and quantitative descriptions, and may match the format of the descriptions provided by the people in response to the surveying of blocks 606-609. In some embodiments, when the responses from the people include values in a qualitative (not quantitative) form, the system may exchange the qualitative values for quantitative values to make the calculations of blocks 610, 612. Though, it should be appreciated that the system may calculate the values in blocks 610, 612 in any suitable manner.

In block 614, the system stores the Ratings, Innovation Potentials, Statuses, and Potential Improvements for each Strategic Priority in one or more storage media. After the values are stored, the process 614 ends. As a result of the process 600, the opportunity evaluation system is configured with information regarding Strategic Priorities, which the opportunity evaluation system may use to evaluate investment opportunities or to calculate other values that may be used in evaluating investment opportunities (see, e.g., process 500 of FIG. 5).

It should be appreciated that embodiments are not limited to surveying people affiliated with an enterprise for information regarding Strategic Priorities in the manner discussed in connection with FIG. 6. For example, in some embodiments, an opportunity evaluation system may survey people regarding a Significance of each Strategic Priority and may refrain from surveying people regarding Status and Potential Improvement for each Priority. In some embodiments, for example, the opportunity evaluation system may be configurable to operate in multiple modes with varying complexity of operations. In a “complex” mode, for example, the system may carry out the process 600 of FIG. 6, while in a “simple” mode, the system may carry out a modified version of the process 600, which may exclude blocks 606 and 610. A “medium” mode may include some or all of the procedures described in connection with FIG. 6 and may omit any suitable combination of procedures. In embodiments in which the system is configurable to operate in different modes, the system may be configurable according to user input, and a user may select a mode in which the system is to operate.

Additionally, in some embodiments the opportunity evaluation system may further evaluate and potentially filter Strategic Priorities for an enterprise based on the values calculated and stored by the system in process 600. For example, in some embodiments the opportunity evaluation system may identify, based on Status, Potential Improvement, and Rating values for Strategic Priorities, which of the Strategic Priorities determined in block 604 should be used by the system to evaluate investment opportunities and which Strategic Priorities should not be used and should be set aside for potential use in the future, during a later evaluation of investment opportunities. For example, in some embodiments, Strategic Priorities with a low Status and high Potential Improvement may be identified as the Priorities by which investment opportunities should be evaluated, as these Priorities may represent the largest potential for the enterprise to achieve goals. As another example, the opportunity evaluation system may determine which Priorities have the potential for the largest impact on the enterprise. The Priorities that have the largest potential for impact may be determined based on the difference between Status and Potential Improvement for a Priority and on the Rating for the Priority. The Rating for a Priority indicates the importance of a Priority to the enterprise and the difference between the Status and Potential Improvement represents the potential for impact on the enterprise. By multiplying this difference and the Rating for a Priority, the system may determine a value that indicates a potential for impact on the enterprise each Priority has. The system may identify Priorities with the largest potential for impact, such as those Priorities with an impact above a threshold or a certain number of Priorities (e.g., the top ten), and store an identification of these Priorities, and use these Priorities in evaluating investment opportunities. The system may then discard or store in a different manner other Priorities.

FIG. 7 illustrates a process 700 that may be implemented in some embodiments for questioning people, affiliated with the enterprise, regarding capability deficits (“GAPPORTUNITIES™,” in the language of the INNOVATION CAPITAL™ system). As discussed above, a capability deficit may be a category into which investment opportunities may be classified. A capability deficit may relate to one or more characteristics of investment opportunities. In some embodiments, a capability deficit may relate to types of innovations that investment opportunities are expected to yield.

The process 700 begins in block 702, in which the system receives input identifying people who are to be questioned regarding expectations of the enterprise regarding one or more GAPPORTUNITIES™ for the enterprise. In some cases, the people who are to be surveyed may be the same group of people for each GAPPORTUNITY™, while in other cases the input may identify different groups of people for different GAPPORTUNITIES™. For example, a group of people who are to be surveyed for a GAPPORTUNITY™ may be people who have specific knowledge regarding the GAPPORTUNITY™. In the case that a GAPPORTUNITY™ relates to innovations in a particular field of technology, the people who are identified for a GAPPORTUNITY™ in block 702 may be people who work in that field of technology, including people who work for the enterprise doing work in that field. Accordingly, different people may be identified for different GAPPORTUNITIES™ that relate to different fields of technology. In some cases, there may be some people who are identified for multiple GAPPORTUNITIES™, including all GAPPORTUNITIES™. For example, leaders of an enterprise may be identified for all GAPPORTUNITIEST™.

As part of receiving an identification of people in block 702, in some embodiments the system may also receive an identification of a weight to assign to responses provided by the people. The indication of weight may be received in embodiments in which different responses from different people are weighted differently, when the set of responses from the people are analyzed collectively. The indication of the weight may be any suitable indication of any suitable weight, as embodiments are not limited in this respect.

In blocks 704-706, the system surveys the identified people regarding the GAPPORTUNITIES™. As discussed above in connection with FIG. 6, the surveying may be done in any suitable manner, including using humans that collect responses from people and input the responses into the system or using electronic surveying through, for example, web pages. Embodiments are not limited to surveying in any particular manner.

In block 704, the identified people are surveyed regarding a Significance of each GAPPORTUNITY™ to each Strategic Priority of the enterprise. The Significance of a GAPPORTUNITY™ represents an expected impact that investments classified in the GAPPORTUNITY™, in general, will have in assisting (including hindering) the enterprise in achieving the Strategic Priority. The Significance of a GAPPORTUNITY™ to a Strategic Priority received from a person represents the person's perception at that time of an impact that the investment opportunities, in general, may have in assisting the enterprise achieve the Strategic Priority. A Significance value may have a positive or negative value, where a positive value indicates an estimate of an impact the investment opportunities may have in helping the enterprise achieve the Priority and a negative value indicates an estimate of an impact the investment opportunities may have in hindering the enterprise from achieving the Priority.

In block 706, the identified people are surveyed regarding an Innovation Potential for each GAPPORTUNITY™. An Innovation Potential for a GAPPORTUNITY™ represents an expected likelihood that there will be an innovation in a GAPPORTUNITY™. The Innovation Potential received in block 706 represents a perception of the person at that time that there will be innovation that can be classified in the GAPPORTUNITY™. The Innovation Potential may be represented in any suitable manner, including as a numeric value such as a percentage value or a value on a scale of 1-10 (or other suitable scale).

In block 708, the opportunity evaluation system calculates a Significance and Innovation Potential for each GAPPORTUNITY™ based on the responses to the surveying of blocks 704, 706. The system may calculate the Significance and Innovation Potential in any suitable manner, as embodiments are not limited in this respect. In some embodiments, the system may calculate the Significance and Innovation Potential based on each of the values provided by the people for a GAPPORTUNITY™ in response to the surveying, such as by calculating a mean, median, or mode for the Significance and Innovation Potential values for a GAPPORTUNITY™. In some embodiments, the values provided by different people may be weighted differently, such as according to weights received in block 702. For example, in some embodiments, people having specific knowledge related to a GAPPORTUNITY™ or working more closely to a GAPPORTUNITY™ may have their responses to the surveying of blocks 704, 706 weighted more in the calculations of block 708. In some such embodiments, a weighted average, weighted according to weights received in block 702, may be calculated in some embodiments based on the values received from the people.

In block 710, the opportunity evaluation system may also gather additional data for each GAPPORTUNITY™. In some embodiments, the additional data may include empirical data. The responses to the surveys of blocks 704, 706 represent the subjective perceptions of people affiliated with the enterprise. Calculating values in block 708 based on multiple responses may aid in eliminating individual biases, but these calculated values will still represent the subjective expectations of the enterprise. Accordingly, in some embodiments, empirical data may be obtained in block 710. The additional data that is retrieved in block 710 may be related to one or more GAPPORTUNITIES™. The additional data may also be related to the enterprise or may be unrelated to the enterprise, and may be retrieved from one or more storage media having information related to the enterprise or from one or more third parties. The additional information may, in some embodiments, be retrieved via one or more computer communication networks, including the Internet, and may be retrieved by the system from one or more computer-based data services.

In embodiments in which empirical data is obtained in block 710, any suitable empirical data may be retrieved. For example, a budget allocated by the enterprise to internal efforts related to a GAPPORTUNITY™ may be retrieved. In cases where a GAPPORTUNITY™ relates to a field of technology, the enterprise's budget may be a research and development budget for the enterprise for technologies in the field. As another example, a budget allocated by others to efforts related to the GAPPORTUNITY™ may be retrieved. In the case that a GAPPORTUNITY™ relates to a field of technology, the budget of others may be budgets allocated to technologies in this field, such as government budgets for technologies in this field or budgets by other investors (e.g., venture capitalists) regarding these technologies.

After the additional data is retrieved, in block 712 the system stores the calculated Significance and Innovation Potential values for each GAPPORTUNITY™ and the additional data in one or more storage media and the process 700 ends. As a result of the process 700, the opportunity evaluation system includes values corresponding to GAPPORTUNITIES™, which the opportunity evaluation system may use to evaluate investment opportunities or to calculate other values that may be used in evaluating investment opportunities (see, e.g., process 500 of FIG. 5).

It should be appreciated that embodiments are not limited to surveying people affiliated with an enterprise for information regarding GAPPORTUNITIES™ in the manner discussed in connection with FIG. 7. For example, in some embodiments, an opportunity evaluation system may survey people regarding a Significance of GAPPORTUNITY™ and may refrain from surveying people regarding Innovation Potential for each GAPPORTUNITY™ and/or may refrain from gathering additional data (including empirical data) for a GAPPORTUNITY™. In some embodiments, for example, the opportunity evaluation system may be configurable to operate in multiple modes with varying complexity of operations. In a “complex” mode, for example, the system may carry out the process 700 of FIG. 7, while in a “simple” mode, the system may carry out a modified version of the process 700, which may exclude blocks 706 and 710. A “medium” mode may include some or all of the procedures described in connection with FIG. 7 and may omit any suitable combination of procedures. In embodiments in which the system is configurable to operate in different modes, the system may be configurable according to user input, and a user may select a mode in which the system is to operate.

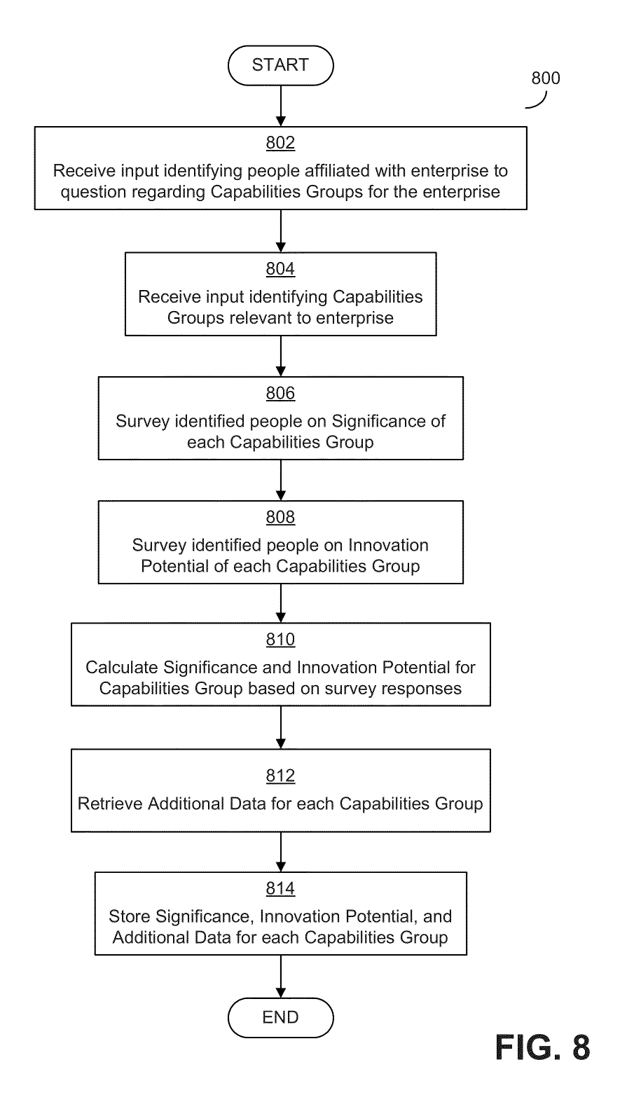

FIG. 8 illustrates a process 800 that may be implemented in some embodiments for questioning people, affiliated with the enterprise, regarding Capabilities Groups for an enterprise. A “Capabilities Group” may be a grouping of Capabilities for an enterprise, which may include one or more GAPPORTUNITIES™ for the enterprise. A Capabilities Group may be any suitable grouping of Capabilities grouped in any suitable manner. In some embodiments, a Capabilities Group may be related to an organizational structure of the enterprise. For example, a Capabilities Group may be a division of the enterprise that is related to a group of Capabilities and/or GAPPORTUNITIES™. In embodiments in which a Capability may correspond to a field of technology, some or all of the Capabilities for an enterprise may correspond to related fields of technology, and a Capabilities Group may be a division of the enterprise that performs work on those fields of technology. For example, the Capabilities Group may be a research team or research department that develops innovations in the related fields or may be an analyst team that analyzes innovations in the related fields. Embodiments are not limited to operating with Capabilities Groups that are based on any particular grouping of Capabilities.

The process 800 begins in block 802, in which the opportunity evaluation system receives input identifying people, affiliated with the enterprise, to be surveyed regarding Capabilities Groups for the enterprise. The people affiliated with the enterprise may be any suitable people, as embodiments are not limited in this respect. In some embodiments, the input may identify different people to be surveyed for different Capabilities Groups. For example, for a Capabilities Group, the people to be survey may include the people with specific knowledge regarding the Capabilities Group. The people with specific knowledge regarding the Capabilities Group may include people who work in the Capabilities Group, in the case that a Capabilities Group corresponds to a division of the enterprise. Accordingly, different people may be identified to be surveyed regarding different Capabilities Groups. In some embodiments, there may be some people who are identified for multiple Capabilities Groups. For example, leaders of the enterprise may be identified as people to be surveyed regarding all Capabilities Groups.

As part of receiving an identification of people in block 802, in some embodiments the system may also receive an identification of a weight to assign to responses provided by the people. The indication of weight may be received in embodiments in which different responses from different people are weighted differently, when the set of responses from the people are analyzed collectively. The indication of the weight may be any suitable indication of any suitable weight, as embodiments are not limited in this respect.

In block 804, the system receives input identifying the Capabilities Groups for the enterprise. The Capabilities Groups may be identified in any suitable manner, including by a human reviewing the GAPPORTUNITIES™ for the enterprise or by a human reviewing an organizational structure for the enterprise. Upon receiving input identifying each of the Capabilities Groups in block 804, the system may store the identification of each of the Capabilities Groups.

In blocks 806 and 808, the system may survey the people identified in block 802 regarding the Capabilities Groups. As discussed above in connection with FIGS. 6 and 7, the surveying may be done in any suitable manner, including using humans that collect responses from people and input the responses into the system or using electronic surveying through, for example, web pages. Embodiments are not limited to surveying in any particular manner.

In block 806, the people are surveyed regarding a Significance of each Capabilities Group to one, some, or all of the Strategic Priorities. A Significance of a Capabilities Group to a Priority may indicate an importance of the Capabilities Group to the Priority. An importance of the Capabilities Group to the Priority may indicate an expected impact that the Capabilities Group may have in assisting (including hindering) the enterprise in achieving the Priority. As discussed above, a Capabilities Group may be related to one or more GAPPORTUNITIES™ and, in some embodiments, an expected impact of the Capabilities Group may indicate, for example, an expected impact that, as a whole, investment opportunities classified according to the GAPPORTUNITIES™ may have in assisting the enterprise in achieving the Priority. The Significance identified by a person in a response may represent the person's perception regarding the expected impact a Capabilities Group may have on the Priority. The Significance may be described in any suitable format, including a qualitative (e.g., “high” or “low”) or a quantitative (e.g., a number on a scale from 1-10) format. Other examples of qualitative and quantitative formats that may be used for the Capabilities Group Significance are described above. A Significance value may have a positive or negative value, where a positive value indicates an estimate of an impact the investment opportunities classified in GAPPORTUNITIES™ related to the Capabilities Group may have in helping the enterprise achieve the Priority and a negative value indicates an estimate of an impact such investment opportunities may have in hindering the enterprise from achieving the Priority.

In block 808, the system surveys the people regarding an Innovation Potential of each of the Capabilities Groups. The Innovation Potential may represent an expectation of Innovation by a Capabilities Group. More particular, the Innovation Potential for a Group may represent an expected likelihood, as perceived by the person providing the response, that there will be innovation in the Capabilities Group. Innovation in the Capabilities Group may include innovation in any of the Capabilities and/or GAPPORTUNITIES™ to which the Capabilities Group relates. The Innovation Potential may be represented in any suitable manner, including as a numeric value such as a percentage value or a value on a scale of 1-10 (or other suitable scale).

In block 810, the system calculates Significance and Innovation Potential values for each Capabilities Group based on the responses provided by the people to the surveying of blocks 806, 808. The system may calculate the Significance and Innovation Potential in any suitable manner, as embodiments are not limited in this respect. In some embodiments, the system may calculate the Significance and Innovation Potential based on each of the values provided by the people for a Capabilities Group in response to the surveying, such as by calculating a mean, median, or mode for the Significance and Innovation Potential values for a Capabilities Group. In some embodiments, the values provided by different people may be weighted differently, such as according to weights received in block 802. For example, in some embodiments, people having specific knowledge related to a Capabilities Group or working more closely to a Capabilities Group may have their responses to the surveying of blocks 806, 808 weighted more in the calculations of block 810. In some such embodiments, a weighted average, weighted according to weights received in block 802, may be calculated in some embodiments based on the values received from the people.

In block 812, the opportunity evaluation system may also gather additional data for each Capabilities Group. The additional data may, in some embodiments, include empirical data. The responses to the surveys of blocks 806, 808 represent the subjective perceptions of people affiliated with the enterprise. Calculating values in block 810 based on multiple responses may aid in eliminating individual biases, but these calculated values will still represent the subjective expectations of the enterprise. Accordingly, in some embodiments, empirical data may be obtained in block 810 related to each Capabilities Group. The additional data that is retrieved in block 810 may be related to the enterprise or may be unrelated to the enterprise, and may be retrieved from one or more storage media having information related to the enterprise or from one or more third parties. The additional information may, in some embodiments, be retrieved via one or more computer communication networks, including the Internet, and may be retrieved by the system from one or more computer-based data services.

In embodiments in which empirical data is retrieved in block 810, any suitable empirical data may be retrieved. For example, a budget allocated by the enterprise to internal efforts related to a Capabilities Group may be retrieved. In cases where a Capabilities Group relates to a division of the enterprise, the division's budget may be empirical data that can be gathered. As another example, in cases where a Capabilities Group relates to a division of the enterprise, a monetary contribution by the division, such as a profit that can be attributed to the division, may be gathered. As a further example, a budget allocated by others to efforts related to the Capabilities Group may be retrieved. In the case that a Capabilities Group relates to related fields of technology, the budget of others may be budgets allocated to technologies in this field, such as government budgets for technologies in this field or budgets by other investors (e.g., venture capitalists) regarding these technologies.

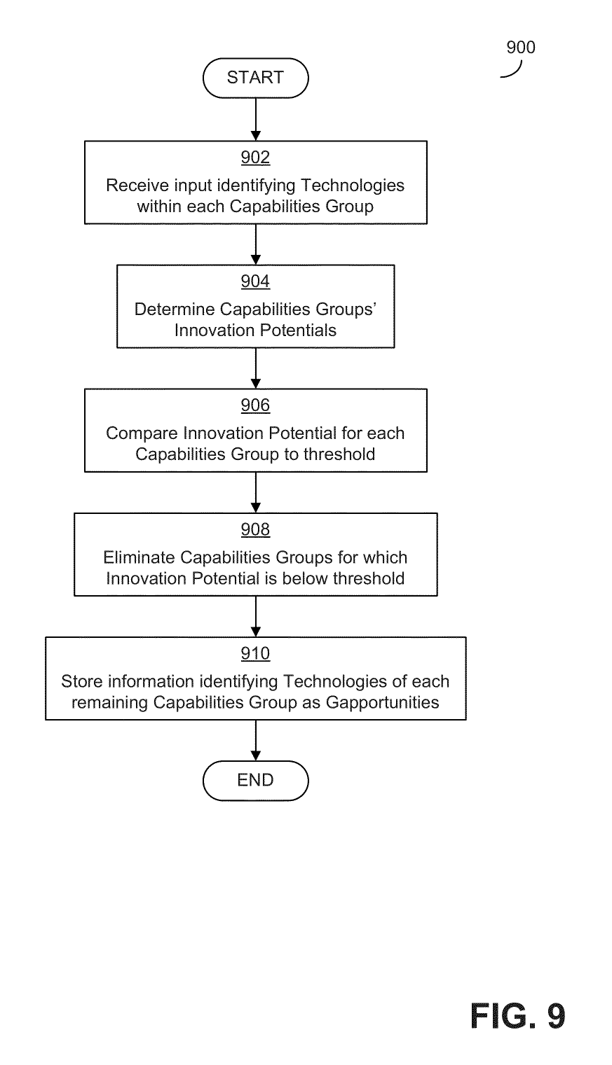

After the additional data is retrieved, in block 814 the system stores the calculated Significance and Innovation Potential values for each Capabilities Group and the additional data in one or more storage media and the process 800 ends. As a result of the process 800, the opportunity evaluation system includes values corresponding to Capabilities Group, which the opportunity evaluation system may use to evaluate investment opportunities or to calculate other values that may be used in evaluating investment opportunities. In some embodiments, as discussed below in connection with FIG. 9, information regarding Capabilities Groups may be used to determine GAPPORTUNITIES™ for an enterprise.

It should be appreciated that embodiments are not limited to surveying people affiliated with an enterprise for information regarding Capabilities Groups in the manner discussed in connection with FIG. 8. For example, in some embodiments, an opportunity evaluation system may survey people regarding a Significance of Capabilities Groups and may refrain from surveying people regarding Innovation Potential for each Capabilities Group and/or may refrain from gathering additional data for a Capabilities Group. In some embodiments, for example, the opportunity evaluation system may be configurable to operate in multiple modes with varying complexity of operations. In a “complex” mode, for example, the system may carry out the process 800 of FIG. 8, while in a “simple” mode, the system may carry out a modified version of the process 800, which may exclude blocks 808 and 812. A “medium” mode may include some or all of the procedures described in connection with FIG. 8 and may omit any suitable combination of procedures. In embodiments in which the system is configurable to operate in different modes, the system may be configurable according to user input, and a user may select a mode in which the system is to operate.

In some embodiments, the opportunity evaluation system may determine the capability deficits by which investment opportunities may be classified. In these embodiments, the system may determine the capability deficits based on information regarding goals and/or expectations of the enterprise. For example, in some embodiments, the opportunity evaluation system may determine the capability deficits based on information regarding Capability Groups for the enterprise. In some embodiments, following the collection of information regarding Capability Groups (via, for example, the process 800 of FIG. 8), the system may filter the Capabilities of the enterprise and thereby filter the capability deficits by which investment opportunities may be classified. Each Capability Group for which information is collected may be related to one or more capability deficits. In some embodiments, when a Capability Group is filtered and set aside based on information regarding the Capability Group, the Capabilities, including the capability deficits, related to the Group may also be filtered and set aside.

FIG. 9 illustrates a process 900 that may be carried out in some embodiments for determining capability deficits (e.g., “GAPPORTUNITIES™”) by which investment opportunities may be classified when the opportunity evaluation system evaluates investment opportunities during a production phase, following an initialization phase. In the process 900, the GAPPORTUNITIES™ are determined based on information regarding Capabilities Groups for an enterprise. As should be appreciated from the foregoing, each Capabilities Group may be associated with one or more Capabilities and/or one or more capability deficits. More particularly, each Capabilities Group may be associated with one or more capability deficits that are available for selection by the system for use in classifying investment opportunities. The capability deficits that are available for selection are termed “GAPPORTUNITIES™” in the INNOVATION CAPITAL™ system. In some cases, the Capabilities that are associated with Capabilities Groups are termed “Technologies.” The Capabilities may be termed Technologies in the INNOVATION CAPITAL™ system because, in that system, each Capability may relate to a field of technology. It should be appreciated, however, that Capabilities of an enterprise may relate to any suitable characteristic(s) of investment opportunities and that Capabilities and capability deficits are not limited to being related to fields of technology.

The process 900 begins in block 902, in which the opportunity evaluation system receives input identifying Technologies related to each Capabilities Group for the enterprise. The input may be received in any suitable manner from any suitable source. The input may be received, in some embodiments, from a human that identifies some or all of the Technologies for each of the Capabilities Groups to the system.

In block 904, the opportunity evaluation system determines an Innovation Potential for each of the Capabilities Groups for the enterprise. The system may determine the Innovation Potential in any suitable manner. In some embodiments, the system may compute the Innovation Potential for some or all of the Capabilities Groups based on survey responses from people affiliated with the enterprise, as discussed above in connection with FIG. 8. In other embodiments, the system may receive the Innovation Potential for some or all of the Capabilities Groups as input from a user. In block 904, the system may retrieve Innovation Potential values (computed and stored by the system or received as input and stored) from one or more storage media.

In block 906, the system compares the Innovation Potential for each Capabilities Group to a threshold. The threshold may be set in any suitable manner, including according to user input. In cases in which the Innovation Potential values for Capabilities Groups are quantitative values, the threshold may also be a quantitative value, and the quantitative values may be compared to the threshold. In cases in which the Innovation Potential values for qualitative, the threshold may also be a qualitative value. As an example of a qualitative threshold, the Innovation Potential values may described using a “low,” “medium,” and “high” scale, and the threshold may specify a minimum qualitative value of medium. Values for Innovation Potential may be in any suitable format and thresholds may be set by any suitable format by which the Innovation Potential values may be evaluated.

In block 908, based on the comparison of block 906, the opportunity evaluation system eliminates Capabilities Groups for which the Innovation Potential fell below the threshold. Eliminating the Capabilities Groups may include storing information indicating that the eliminated Groups will not be used to evaluate investment opportunities. When a Capabilities Group is evaluated, the Capability or Capabilities, which may include capability deficits, that are related to the Capabilities Group may also be eliminated. Accordingly, in block 908, the system may store information indicating that one or more Capabilities or capability deficits (e.g., “Technologies”) may not be used to classify investment opportunities, when the Innovation Potential for a related Capabilities Group is below the threshold.

As a result of the filtering of blocks 906, 908, one or more Capabilities Groups and one or more related Capabilities (e.g., “Technologies”) or capability deficits may remain and may be used to evaluate investment opportunities. Accordingly, in block 910 the system may store information identifying one or more capability deficits that may be used to classify investment opportunities. The information that identifies that a capability deficit may be used to classify an investment opportunity may be information that identifies a capability deficit as a GAPPORTUNITY™ for the enterprise.

Once information identifying the GAPPORTUNITIES™ is stored in block 910, the process 900 ends. As a result of the process 900, the opportunity evaluation system is configured with information regarding one or more capability deficits into which investment opportunities may be classified for evaluation by the opportunity evaluation system.

It should be appreciated that embodiments are not limited to determining capability deficits by which investment opportunities may be classified using the process 900 of FIG. 9. Embodiments may determine such capability deficits in any suitable manner. In some other embodiments, for example, capability deficits may be filtered based at least in part on an expected impact of Capability Groups (e.g., a “Significance” of a Capabilities Group). For example, instead of the Innovation Potential values that are used in the process 900, a system may use Significance values to filter Capabilities Groups. As another example, a system may, in some embodiments, use a combination of Significance values and Innovation Potential values to filter Capabilities Groups.

The procedures described above in connection with FIGS. 5-9 may be carried out by an opportunity evaluation system during an initialization phase, during which the system is configured with information regarding goals and expectations of an enterprise. The opportunity evaluation system is configured with this information such that, during a production phase, the system may evaluate investment opportunities to determine a value that each investment opportunity presents to the enterprise. For example, the system may use the information to determine a strategic value that each investment opportunity presents to the enterprise.

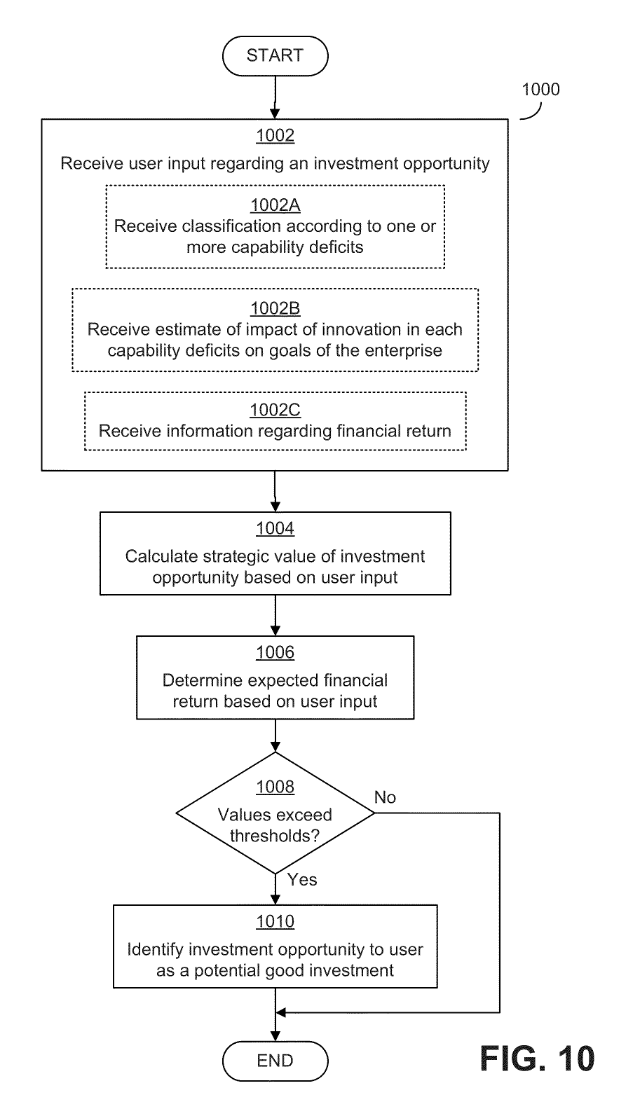

FIG. 10 illustrates an example of a process 1000 that may be implemented in some embodiments for scoring and evaluating investment opportunities based on a value the investment opportunities presents to the enterprise. It should be appreciated that embodiments are not limited to scoring and evaluating investment opportunities using the process of FIG. 10 and that other processes may be used.

Prior to the start of the process 1000, an opportunity evaluation system may be configured with information regarding goals and expectations of an enterprise. The system may be configured with information identifying capability deficits (“GAPPORTUNITIES™”) by which investment opportunities may be classified. The system may also be configured with a value for each capability deficit indicating an estimated impact that investments, in general, that are classified in the capability deficit will have in assisting the enterprise in achieving one, some, or all goals of the enterprise (“GAPPORTUNITY™ Value”). Additionally, the system may be configured with information regarding thresholds by which investment opportunities can be evaluated, such as thresholds to which a value computed for an investment opportunity may be compared.

The process 1000 begins in block 1002, in which the system receives as input from a user information regarding an investment opportunity. The input may be received in any suitable manner from any suitable user, as embodiments are not limited in this respect. In some embodiments, the information regarding an investment opportunity may be received from a human user (e.g., user 170 of FIG. 1) via a web page interface that enables the human user to enter various characteristics of an investment opportunity.

As part of receiving information regarding the investment opportunity, the system may receive in block 1002A a classification of the investment opportunity according to capability deficits established for the enterprise by the system. The classification received in block 1002A may include an identification of one or more capability deficits into which the investment opportunity is classified. As should be appreciated from the foregoing, capability deficits may be related to any suitable characteristics of investment opportunities. An investment opportunity may be classified into a capability deficit when the investment opportunity has the characteristic to which the capability deficit relates. For example, in some embodiments, capability deficits may relate to types of innovations that opportunities are expected to yield. When an investment opportunity is expected to produce a type of innovation, the investment opportunity may be classified in the capability deficit.

In some embodiments, as part of receiving information regarding the investment opportunity in block 1002, the system may in some cases receive in block 1002B information regarding an estimate of an impact that one or more innovations that are expected to result from the investment opportunity may have on goals of the enterprise. The estimate of the impact may be received in cases where an investment opportunity is expected to produce one or more innovations. In some cases, as mentioned above, the one or more capability deficits into which an investment opportunity is classified may each be related to a type of innovation. In some cases in which an investment opportunity is expected to produce multiple innovations, the investment opportunity may be classified into multiple capability deficits that each correspond to different innovations of those multiple innovations. In some embodiments, when an investment opportunity is expected to yield multiple innovations and is classified into multiple deficits, the estimates of impact received in block 1002B may each correspond to an innovation and to a deficit. In cases where an estimate is related to a particular innovation, the estimate of the impact may be an estimate (of the user from which the input is received in block 1002) regarding how great an impact the innovation will have in assisting the enterprise in achieving one, some, or all of the goals of the enterprise. More particularly, the estimate of the impact may be the user's assessment of an impact that the innovation will have if the enterprise engages with the investment opportunity, makes an investment, and the investment opportunity successfully produces the innovation. The estimate of the impact may be in any suitable format, as embodiments are not limited in this respect. In some embodiments, the estimate may be a numeric value that is a percentage value or a value on a scale of 1-10 (or other suitable scale).

In block 1002C, as part of receiving the user input regarding the investment opportunity in block 1002, the system may also receive from the user one or more estimates of a financial return for the investment opportunity. The one or more estimates may be any suitable characterization of a financial return that is estimated by the user for the investment opportunity. In some embodiments, the estimate(s) of financial return may include an estimate of an investment return for the investment opportunity, which represents the financial return that can be expected merely from the investment, such as the financial return that can be expected merely from purchasing equity in the investment opportunity, purchasing debt of the investment opportunity, or engaging with the opportunity in any other way or providing financing to the investment opportunity in any other way. The investment return may be based on the terms of the investment. The estimate(s) of financial return may additionally or alternatively include an estimate of a consequential return, which may represent a monetary gain that the enterprise is expected to realize from innovations or other suitable results of the investment opportunity that may be commercially advantageous to the enterprise, if the investment opportunity is successful in achieving an objective of the opportunity and/or if the engagement with the investment opportunity by the enterprise is successful. In the INNOVATION CAPITAL™ system, the investment return is termed the “eROI” and the consequential return is termed the “fROI.” Taken together, in the INNOVATION CAPITAL™ system, the “eROI” and “fROI” are termed “$ROI” ($ROI=eROI+fROI).

In some embodiments, other characteristics of an investment opportunity may also be received from the user in block 1002. Any suitable information regarding an investment opportunity may be received, as embodiments are not limited in this respect. In some embodiments, for example, the user may provide input regarding an estimate (by the user or by any other suitable source of an estimate) of risk associated with the investment opportunity, which may be an estimate of any suitable form of risk. In some cases, the risk may be a risk that the investment opportunity will not be successful and the investment may be lost. In some embodiments, the user may provide input regarding a time associated with the investment opportunity, such as an estimate of an amount of time that the investment opportunity will take to be successful (e.g., successful in developing an innovation).

Once the user input regarding the investment opportunity is received in block 1002, the opportunity evaluation system calculates a numeric value indicating a strategic value of the investment opportunity to the enterprise. The opportunity evaluation system may calculate the numeric value indicating the strategic value in any suitable manner, as embodiments are not limited in this respect. In some embodiments, the system may calculate the strategic value based at least in part on the classification of the investment opportunity received in block 1002. As discussed above, in some embodiments each capability deficit may be associated with an estimate of an impact that, in general, investment opportunities classified in the capability deficit will have in assisting the enterprise in achieving one, some, or all of the goals of the enterprise (see, e.g., FIG. 5). In the INNOVATION CAPITAL™ system, this estimate is termed the “GAPPORTUNITY™ Value.” In some embodiments, in block 1004 the system may calculate a numeric value that is a strategic value of an investment based on these estimates, including some or all of the estimates for capability deficits into which the investment opportunity is classified.

For example, in cases where an investment opportunity is classified into one capability deficit, the system may set the estimate for that one deficit as the strategic value of the investment. In cases where an investment opportunity is classified into multiple capability deficits, the system may select between the estimates for some or all of the capability deficits or may perform one or more computations on estimates for some or all of the capability deficits. In some embodiments, for example, the system may select a highest or lowest of the estimates, or select any other of the estimates, and set the strategic value of the investment as the selected estimate. In other embodiments, the system may sum some or all of the estimates. In still other embodiments, the system may average some or all of the estimates to calculate the strategic value or otherwise perform a computation on some or all of the estimates to calculate the strategic value.

In embodiments in which the system receives, in block 1002B, one or more estimates of an impact that an innovation associated with an investment opportunity will have in assisting the enterprise achieve one, some, or all of the goals, the estimate(s) may be used in calculating the strategic value in block 1004. For example, in some embodiments these estimates may be associated with innovations and may therefore each correspond to a capability deficit by which the associated innovation is classified. In these embodiments, the estimated impacts of the innovations of the investment opportunity may be used together with the estimated impacts of the corresponding capability deficits. For example, in some embodiments an estimated impact of an innovation may be used to weight an estimated impact of a corresponding capability deficit, such as by multiplying the estimated impact values. In one specific example, a capability deficit may have an estimated impact for investments, in general, of 4.0. An investment opportunity may be expected to yield an innovation that is related to that capability deficit, and the user may estimate that an impact of that innovation is 2.0. The system may weight the estimated impact of the capability estimate (4.0) by the estimated impact of the innovation (2.0) by multiplying the values: 4.0*2.0. In embodiments that weight the estimated impacts in this manner, the weighting may be done before computations involving the estimated impacts of the capability deficits are evaluated. In another specific example, the user may estimate the impact of the innovation at 0.5 and the estimated impact for the capability deficit may be 4.0, and the system may weight the estimated impact of the innovation at 2.0 (4.0*.5). Using examples of the preceding paragraph, the system may weight the estimated impacts of the capability deficits before selecting or averaging the estimated impacts of the capability deficits.

In block 1006, the system determines an estimated financial return of the investment opportunity based on the user input received in block 1002. The estimated financial return may be input by the user in block 1002 in some embodiments, and in these embodiments determining the estimated financial return may include retrieving the estimated financial return from one or more storage media. In other embodiments, the user may input multiple estimates of financial returns in block 1002, including, for example, an estimate of an investment return and an estimate of a consequential return. In these embodiments, the system may perform any suitable computation on the estimates of financial return, including averaging, summing, or otherwise computationally combining the returns.

In block 1008, the system may evaluate the strategic value computed for the investment opportunity in block 1004 and the estimated financial return computed for the investment opportunity in block 1006 by comparing the values to one or more thresholds. The thresholds may be set by user input or determined by the system from user inputs or by computations, and may be configurable to any suitable value, in any suitable manner, as embodiments are not limited in this respect. To compare the values to the thresholds, the system may determine whether both values exceed the thresholds. If the system determines that the values exceed the thresholds, the system identifies the investment opportunity as a potential good investment in block 1010. To identify the investment opportunity as a potential good investment, the system may store information identifying the investment opportunity as a potential good investment and may display information to a user (e.g., user 170 of FIG. 1) identifying the investment opportunity and indicating that the system determined that the opportunity may be a good investment for the enterprise. Once the information is stored and/or displayed, the process 1000 ends.

If the system determines that the values do not exceed the thresholds, then the system may determine that the investment opportunity may not be a good investment for the enterprise and the process 1000 ends. In some embodiments, however, the system may store information identifying that the investment opportunity was determined not to be a good investment and/or display a message indicating the same to a user.

While the process 1000 was discussed above as comparing only the strategic value and the estimated financial return to thresholds, it should be appreciated that embodiments are not limited to operating with only these two thresholds. Embodiments may operate with any suitable number of thresholds for any suitable values associated with an investment opportunity. For example, as discussed above, an investment opportunity may be associated with a risk value or a time value, which may be received from a user and/or calculated by the system based on user input. In embodiments in which a risk value or time value is received or calculated by the system, the system may compare the risk value and/or time value to thresholds. Based on these other thresholds, the system may determine whether the investment opportunity reflects a good opportunity.

In some embodiments, such as the embodiment of FIG. 10, the opportunity evaluation system may determine that an investment opportunity is potentially a good investment for an enterprise when values for the investment opportunity exceed all of the thresholds set for the system (or otherwise favorably compare to thresholds, such as in the case of thresholds that set maximum values or other types of thresholds). Embodiments are not limited to identifying potential good investments in this manner. In some other embodiments, investment opportunities for which values do not exceed all thresholds may be identified as potential good investments and identified to a user by the system as investment opportunities that should be further considered.

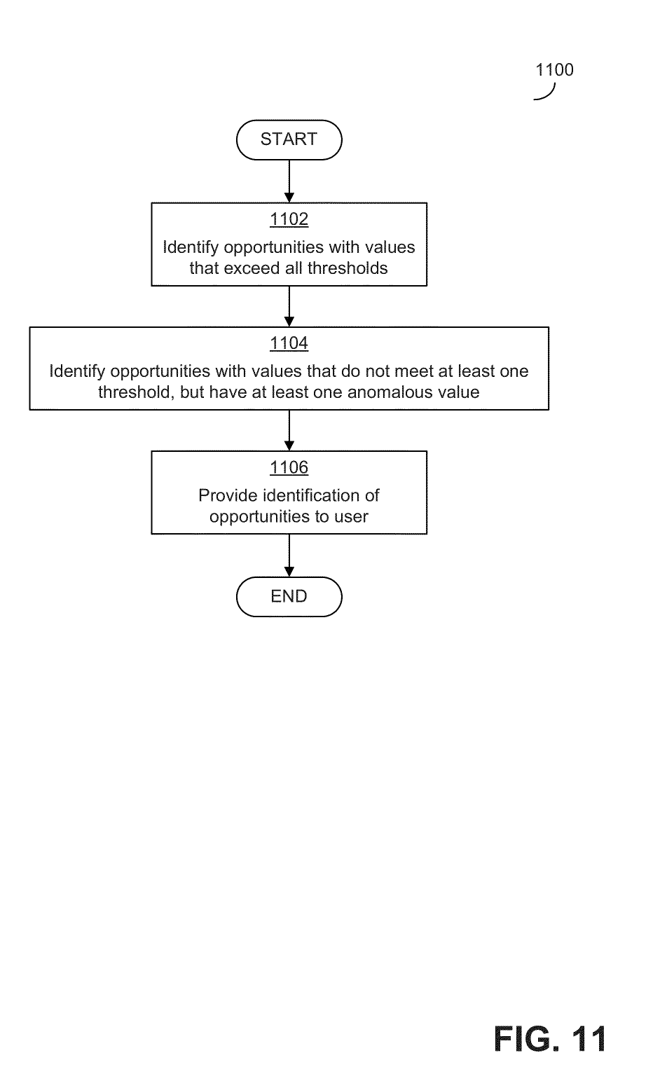

FIG. 11 illustrates a process 1100 that may be implemented by some opportunity evaluation systems to identify investment opportunities that may be potential good investments but for which values do not exceed all thresholds associated with the enterprise. Prior to the start of the process 1100, one or more investment opportunities may be evaluated by the system to determine one or more values for each investment opportunity, such as through the process 1000 of FIG. 10.

The process 1100 begins in block 1102, in which the system identifies investment opportunities with values that exceed all thresholds (or have values that otherwise favorably compare to all thresholds, in the case of different types of thresholds). In block 1104, the system may evaluate the other investment opportunities that do not have values that exceed all thresholds. In particular, the system may in block 1104 evaluate these investment opportunities to determine whether the investment opportunities may be potentially good investments based on one or more of the values. For example, as discussed above in connection with FIG. 3B, some enterprises may consider investment opportunities with low strategic value but high estimated financial returns to be potential good investments, due primarily to the high estimated financial return. In another example, an investment opportunity may score highly on one facet of a strategic value analysis but not others, such as be classified as related to one or more capability deficits with estimated impacts that are higher than the estimated impacts of other capability deficits in which the investment opportunity is classified. Based on the high estimated value(s) for one or more capability deficits, the system may identify the investment opportunity as a potential good investment.

Accordingly, in block 1104, the opportunity evaluation system evaluates each of the investment opportunities for which the values did not exceed all thresholds to determine whether any of the values are anomalous. The values that are evaluated by the system in block 1104 may be any suitable value of any suitable characteristic of an investment opportunity. In some embodiments, for example, the computed values of estimated financial return and strategic value may be evaluated. In other embodiments, values for estimated impacts for one or more capability deficits in which an investment opportunity is classified may be additionally or alternatively evaluated.

Anomalous values for an investment opportunity may be determined by evaluating corresponding values for other investment opportunities, which may include investment opportunities that were and were not identified in block 1102 as potential good investments. For example, the strategic value of an investment opportunity may be compared to the strategic value for other investment opportunities, and an estimated financial return for an investment opportunity may be compared to the estimated financial return for other investment opportunities. Values that deviate from the corresponding values for other investment opportunities may be flagged. The system may determine a deviation in any suitable manner, as embodiments are not limited in this respect. In some embodiments, for example, a variance of a value for an investment opportunity from a mean for the corresponding values of other investment opportunities may be calculated and used to identify deviations. In other embodiments, a highest value out of the corresponding values, or a highest value that has more than a threshold amount of difference (including raw value or percentage difference) from the next highest value may be identified.

If the system identifies in block 1104 any investment opportunities that have anomalous values, these investment opportunities may be presented to a user (e.g., user 170 of FIG. 1) as potential good investment opportunities in block 1106. In some embodiments, the system may identify the investment opportunities in block 1106 in a different manner than the investment opportunities identified in block 1102, such as by displaying the opportunities in separate lists or graphically separating the sets of opportunities in some manner.

Once the system identifies the investment opportunities with anomalous values to the user in block 1106, the process 1100 ends. Following the process 1100, a user of the opportunity evaluation system may view the information regarding investment opportunities that the system identified as potentially valuable. Based on that information, the user may review investment opportunities and identify opportunities in which the enterprise is to invest.

Information regarding investment opportunities may be output by the system in any suitable manner, as embodiments are not limited in this respect. In some embodiments, the opportunity evaluation system may output information regarding investment opportunities using a graphical comparison. Examples of graphical comparisons are illustrated above in FIGS. 3A and 3B.

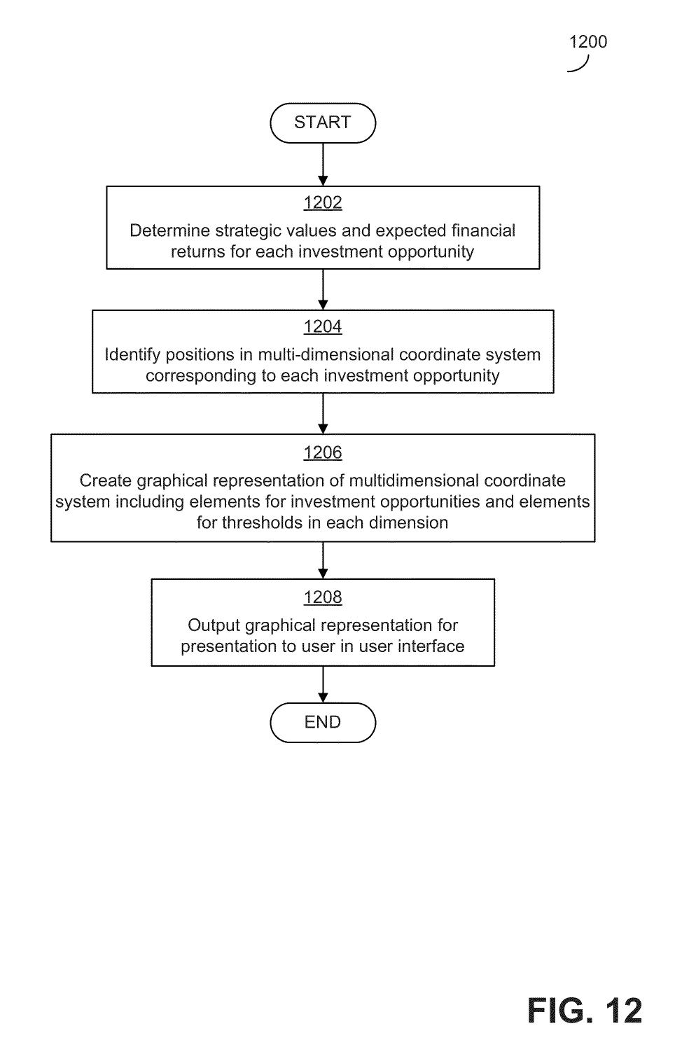

FIG. 12 illustrates a process 1200 that may be implemented in some embodiments for creating a graphical comparison. The process 1200 begins in block 1202, in which strategic values and estimated financial returns for one or more investment opportunities are determined by the system. The system may determine the values in any suitable manner, including according to the process 1000 discussed above in connection with FIG. 10. As discussed above in connection with FIG. 10, in some embodiments the system may additionally determine other values for investment opportunities, including time values and risk values or values regarding any other suitable characteristic of an investment opportunity.

In block 1204, the system identifies positions, in a multi-dimensional coordinate system, that correspond to each investment opportunity. The multi-dimensional coordinate system may include dimensions that correspond to some or all of the values determined in block 1202. For example, the coordinate system may include dimensions that correspond to strategic value and estimated financial return for an investment opportunity. The coordinate system may, in some embodiments, additionally or alternatively include dimensions that correspond to risk values, time values, or other values that were determined in block 1202. Each dimension may include a scale and the coordinate system may include positions that correspond to values on each scale of each dimension. Accordingly, the system may determine in block 1204 a position in the coordinate system for each investment opportunity, where the position corresponds to values determined for the investment opportunity in block 1202.

In block 1206, the system creates a graphical representation of the coordinate system. The graphical representation that is created may be similar to the graphical comparison illustrated in FIG. 3A, though embodiments are not limited to producing any particular graphical comparison. In some embodiments, the graphical representation of the coordinate system may include graphical identifiers for the investment opportunities placed at locations that correspond to the positions in the coordinate system determined in block 1204. The graphical representation may also, in some embodiments, include graphical elements that correspond to thresholds established by the system for the values determined in block 1202. As discussed above in connection with FIGS. 10 and 11, the thresholds may set minimum values, maximum values, or other criteria for values determined in block 1202 for an investment opportunity to be considered by the system to be a potential good investment for the enterprise. Graphical elements corresponding to the thresholds may be inserted into the graphical representation created in block 1206, as such as the graphical elements illustrated above in FIG. 3A.

Once the graphical representation is created in block 1206, the system outputs the graphical representation in block 1208. The graphical representation may be output in any suitable manner, including by displaying the graphical representation in a user interface of a computing device, storing the representation in a storage medium or transmitting the representation via one or more computer communication networks (including the Internet) for storage or display on one or more other computing devices (e.g., computing device 172 of FIG. 1). Once the representation is output in block 1208, the process 1200 ends.

As should be appreciated from the foregoing, investment opportunities are evaluated by an opportunity evaluation system in embodiments based on goals and expectations of an enterprise set in advance by the enterprise. The goals and expectations of the enterprise represent predictions of goals of the enterprise and predictions of how those goals may be best achieved or what outside influences may assist (or hinder) the enterprise in achieving the goals. In some cases, an enterprise's predictions may not match reality. As the system is used in a production phase to evaluate investment opportunities and opportunities are selected by an enterprise for investment, a disparity may arise between the goals and expectations with which the system is configured and an investment strategy that is followed by an enterprise or investment opportunities that are available to the enterprise.

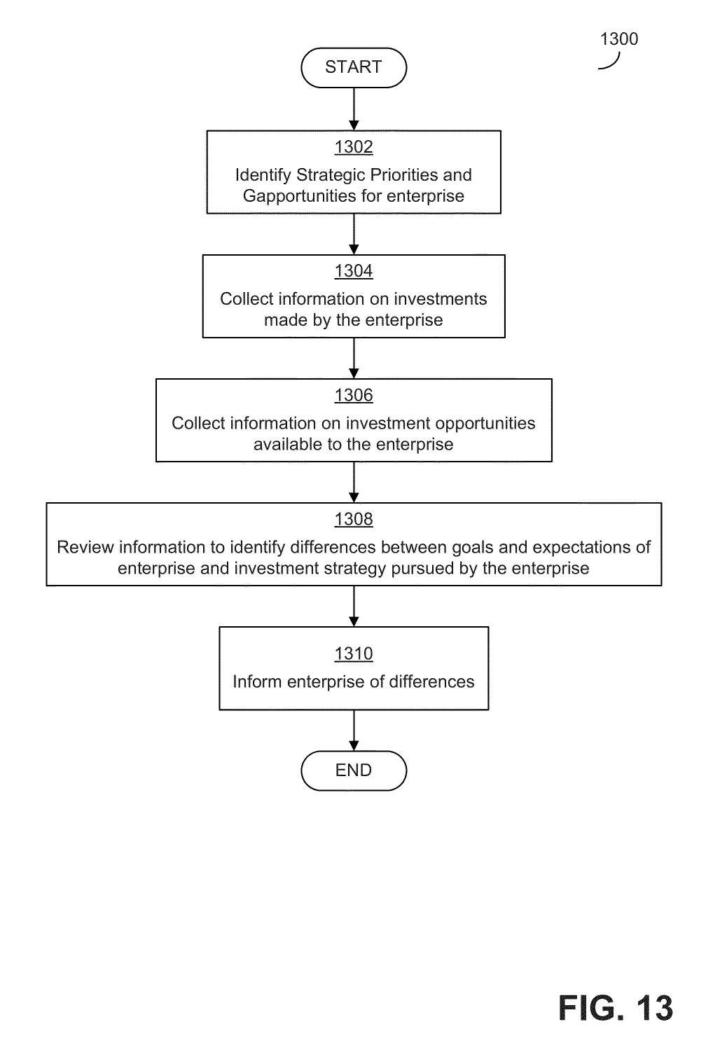

FIG. 13 illustrates a process 1300 that may be implemented by an opportunity evaluation system in some embodiments to identify differences between the goals and expectations with which the system is configured, which represent an estimate of an investment strategy for an enterprise, and an investment strategy followed by the enterprise following configuration of the system. Prior to the start of the process 1300, an opportunity evaluation system may be configured with information regarding an enterprise and may evaluate investment opportunities based on that information, such as using processes discussed above in connection with FIGS. 1-12.

The process 1300 begins in block 1302, in which the system identifies the Strategic Priorities and GAPPORTUNITIES™ for an enterprise. The system may identify, in block 1302, the Strategic Priorities and GAPPORTUNITIES™ with which the enterprise was configured during an initialization phase and based on which the enterprise has been evaluating investment opportunities. The system may identify the Strategic Priorities and GAPPORTUNITIES™ by retrieving information regarding these from one or more storage media.

In block 1304, the system collects information regarding investments made by the enterprise. In some embodiments, when an enterprise makes an investment, the enterprise may input to the system an identification of the investment opportunity in which enterprise invested. Information regarding the investment opportunity may have been previously input to the system and, as such, the enterprise may merely identify an investment opportunity for which the system previously received information. The information that is collected in block 1304 may include information on characteristics of the investment opportunities in which the enterprise invested, including information on GAPPORTUNITIES™ into which the investments were classified.

In block 1306, the system may collect information regarding investment opportunities that have been available to the enterprise. The information collected in block 1306 may include information for some or all of the investment opportunities that were evaluated by the system in a time period. The information that is collected in block 1306 may include information on characteristics of the investment opportunities, including information on GAPPORTUNITIES™ into which the investment opportunities were classified.

In block 1308, the system may review the information collected in blocks 1302-1306 to identify differences between the goals and expectations of the enterprise and the investment strategy pursued by the enterprise. For example, if the system had been configured with values indicating a low Significance for a particular GAPPORTUNITY™ and the enterprise has been making many investments that are classified in that GAPPORTUNITY™, this may indicate that the Significance value for that GAPPORTUNITY™ may have been originally incorrect and/or is now incorrect because it is outdated with respect to the enterprise's current investment strategy. Similarly, if the system was configured with a value indicating a high Significance for a GAPPORTUNITY™ and the system is making no or few investments in the GAPPORTUNITY™, the Significance value may be incorrect. Additionally or alternatively, in some embodiments the system may make similar determinations with respect to an Innovation Potential for a GAPPORTUNITY™, based on the innovations associated with investment opportunities in which the enterprise invests and/or based on investment opportunities that are available to the enterprise. In some embodiments, the system may additionally or alternatively make determinations regarding a Significance value for a Strategic Priority, such as based on whether investment opportunities that may assist the enterprise in achieving the Priority are available and the enterprise is choosing not to invest in those investment opportunities. The system may make the determinations of block 1308 in any suitable manner, such as by analyzing trends in characteristics of investment opportunities and trends in investments made by the enterprise.

In block 1310, the system outputs the differences identified by the system in block 1308, if any. The system may output the differences to inform the enterprise and may output them in any suitable manner, such as by outputting the differences to a storage medium, displaying the differences in a user interface, or transmitting the differences over a computer communication network such that the differences may be stored or displayed on another computing device. Once the differences are stored, the process 1300 ends.

As discussed above, a Capabilities Group may be related to an organizational structure of an enterprise. In some embodiments in which one or more of the Capabilities Groups are related to organizational structure, the opportunity evaluation system may be adapted to determine that an organizational structure of an enterprise may not be well arranged for assisting the enterprise in identifying and taking advantage of innovation. For example, the opportunity evaluation system may review the Capabilities and GAPPORTUNITIES™ that are grouped into the different Capabilities Groups and determine trends in the Capabilities/GAPPORTUNITIES™ or in investment opportunities that relate to the Capabilities/GAPPORTUNITIES™. For example, the system may identify a group of GAPPORTUNITIES™ that relate to a common Strategic Priority or that have a high Significance to a Strategic Priority. The system may also identify a group of investment opportunities in which the enterprise invested that have multiple GAPPORTUNITIES™ in common. When the system identifies groupings of GAPPORTUNITIES™ in this way from the Strategic Priorities or from the investments of the enterprise, the system may determine that these GAPPORTUNITIES™ should be grouped together in a Capabilities Group, such that a common group of people may focus on the GAPPORTUNITIES™ of the group, which may be more efficient or otherwise advantageous as compared to multiple disparate groups working on these potentially-related GAPPORTUNITIES™. The system may therefore recommend that the enterprise restructure such that an organizational unit is created that corresponds to a Capabilities Group that includes these GAPPORTUNITIES™.

In some embodiments, the opportunity evaluation system may be available over one or more communication networks (including the Internet) for use by multiple different enterprises. An organization that operates the opportunity evaluation system may make the system available for a fee to the different enterprises, and the system may be configured with information regarding the multiple different enterprises and may use the information regarding each enterprise to evaluate investment opportunities for that enterprise.

In such embodiments, over time the system may store a large amount of information regarding goals and expectations of enterprises as well as a large amount of information regarding investment opportunities that these enterprises have identified and evaluated. Information regarding a particular enterprise may be considered private and confidential to that enterprise by the system and the organization that operates the system. This information may be valuable in the aggregate, however, when the information cannot identify a particular enterprise. The aggregated information may provide a guide to what investors, including corporate venture capitalists or other investors, consider important in the market and a guide to what entrepreneurs, including entrepreneurs forming companies in which investors may invest, consider important in the market.

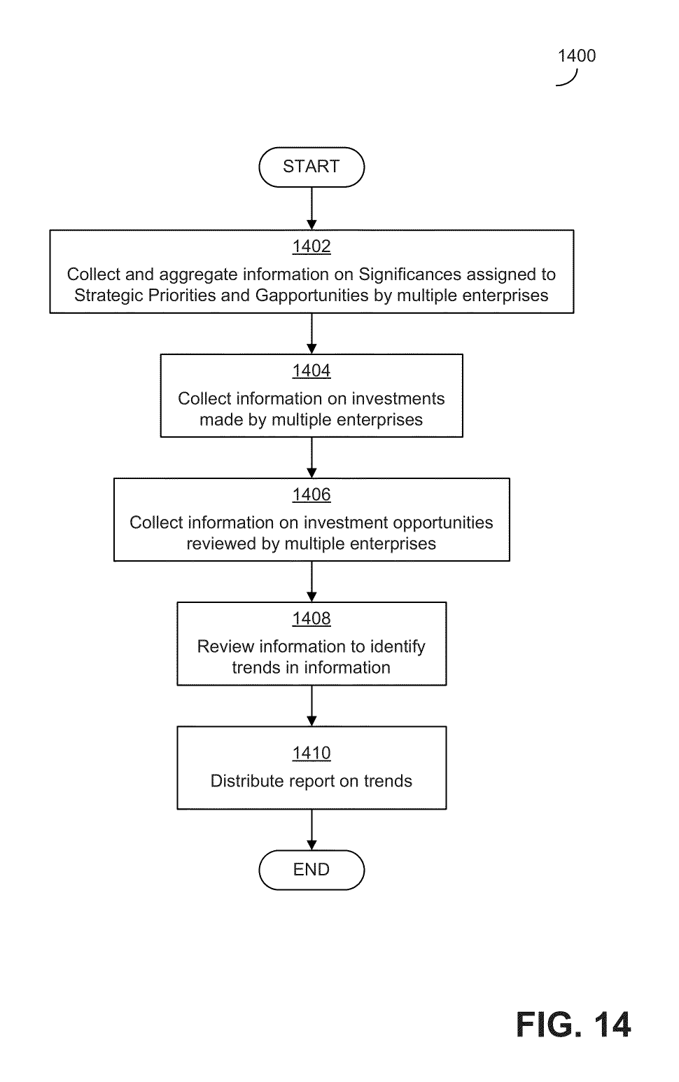

FIG. 14 illustrates a process 1400 that may be implemented in an opportunity evaluation system in some embodiments to identify market trends based on information regarding enterprises and investment opportunities. The process 1400 begins in block 1402, in which the system collects and aggregates information on the GAPPORTUNITIES™ and Strategic Priorities for multiple enterprises that use the opportunity evaluation system. The system may collect and aggregate information on a perceived Significance of each of the GAPPORTUNITIES™ and Strategic Priorities. The Significance indicates perceived importance of each GAPPORTUNITIES™ and Priorities to the enterprises and therefore may indicate a value placed by these enterprises on the GAPPORTUNITIES™ and Priorities.

In block 1404, the system collects information on investments made by the enterprises. This information may include any suitable information regarding the investments, including characteristics of the investments. Characteristics of the investments may include information on GAPPORTUNITIES™ into which the investment opportunities in which the enterprise invested were classified. This information may further indicate a value placed by the enterprises on various concepts, including where investors are directed their funds.

In block 1406, the system collects information on investment opportunities reviewed by the enterprises, which may include information on some or all of the investment opportunities for which information was entered into the system. The information on the investment opportunities may include any suitable information regarding the investments, including characteristics of the investments. Characteristics of the investments may include information on GAPPORTUNITIES™ into which the investment opportunities were classified. This information may indicate a value placed by entrepreneurs on various concepts. As some or all of the investment opportunities may correspond to one or more entrepreneurs, the information on investment opportunities may indicate where entrepreneurs are directing their efforts.

In block 1408, the system analyzes the information collected in blocks 1402-1406. The system may analyze the information to identify trends in the information. The trends may include trends in the information over time, such as trends in what types of opportunities investors invest in over time or trends in what types of investment opportunities are available over time. For example, if investors reduce an amount of funds invested in innovations of one type over time and increase an amount of funds invested in innovations of another type over that time, this may be noteworthy information regarding the state of the marketplace. Trends may be similarly identified in investment opportunities available to investors.

In block 1410, the system compiles and distributes reports on the trends identified in block 1408. The system may distribute the report in any suitable manner, including by storing the report in one or more storage media or transmitting the report via one or more computer communication networks. The report may be distributed to investors who are seeking to determine trends in opportunities that are available or trends in what their competitors are doing. The report may also be distributed to entrepreneurs who are seeking to determine where to direct their energies such that companies they form have a higher likelihood of receiving investment.

Once the report is distributed in block 1410, the process 1400 ends.

Techniques operating according to the principles described herein may be implemented in any suitable manner. Included in the discussion above are a series of flow charts showing the steps and acts of various processes that evaluate investment opportunities for an enterprise. The processing and decision blocks of the flow charts above represent steps and acts that may be included in algorithms that carry out these various processes. Algorithms derived from these processes may be implemented as software integrated with and directing the operation of one or more single- or multi-purpose processors, may be implemented as functionally-equivalent circuits such as a Digital Signal Processing (DSP) circuit or an Application-Specific Integrated Circuit (ASIC), or may be implemented in any other suitable manner. It should be appreciated that the flow charts included herein do not depict the syntax or operation of any particular circuit or of any particular programming language or type of programming language. Rather, the flow charts illustrate the functional information one skilled in the art may use to fabricate circuits or to implement computer software algorithms to perform the processing of a particular apparatus carrying out the types of techniques described herein. It should also be appreciated that, unless otherwise indicated herein, the particular sequence of steps and/or acts described in each flow chart is merely illustrative of the algorithms that may be implemented and can be varied in implementations and embodiments of the principles described herein.

Accordingly, in some embodiments, the techniques described herein may be embodied in computer-executable instructions implemented as software, including as application software, system software, firmware, middleware, embedded code, or any other suitable type of computer code. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

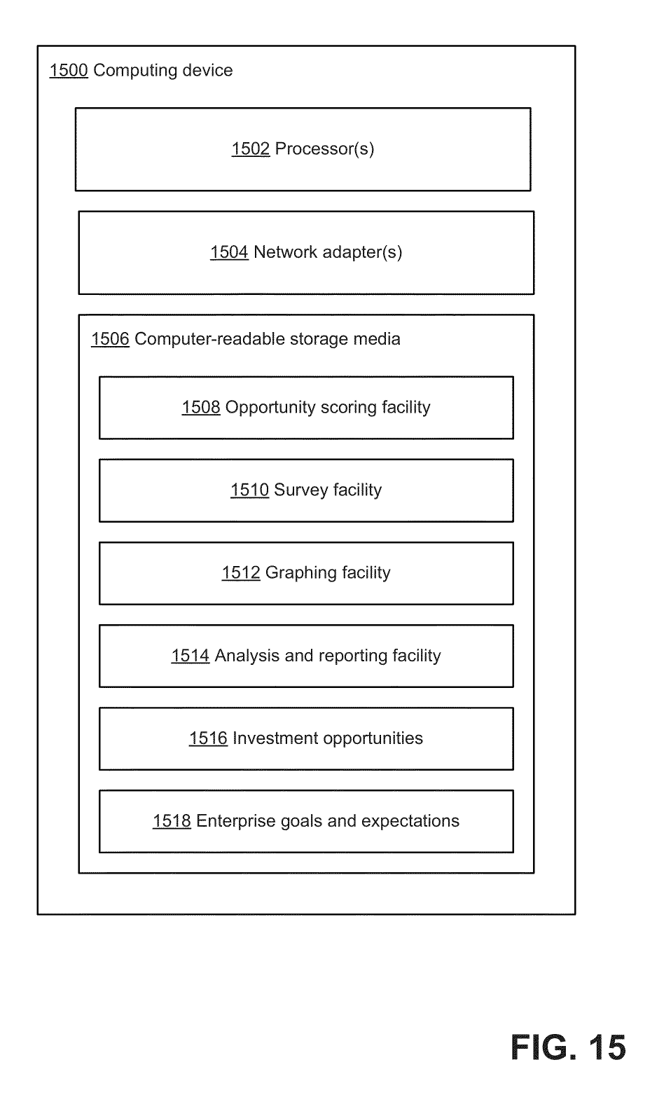

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner, including as computer-readable storage media 1506 of FIG. 15 described below (i.e., as a portion of a computing device 1500) or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

In some, but not all, implementations in which the techniques may be embodied as computer-executable instructions, these instructions may be executed on one or more suitable computing device(s) operating in any suitable computer system, including the exemplary computer system of FIG. 1, or one or more computing devices (or one or more processors of one or more computing devices) may be programmed to execute the computer-executable instructions. A computing device or processor may be programmed to execute instructions when the instructions are stored in a manner accessible to the computing device or processor, such as in a data store (e.g., an on-chip cache or instruction register, a computer-readable storage medium accessible via a bus, a computer-readable storage medium accessible via one or more networks and accessible by the device/processor, etc.). Functional facilities comprising these computer-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing device (co-located or geographically distributed) dedicated to executing the techniques described herein, one or more Field-Programmable Gate Arrays (FPGAs) for carrying out the techniques described herein, or any other suitable system.

FIG. 15 illustrates one exemplary implementation of a computing device in the form of a computing device 1500 that may be used in a system implementing techniques described herein, although others are possible. It should be appreciated that FIG. 15 is intended neither to be a depiction of necessary components for a computing device to operate as an opportunity evaluation system in accordance with the principles described herein, nor a comprehensive depiction.

Computing device 1500 may comprise at least one processor 1502, a network adapter 1504, and computer-readable storage media 1506. Computing device 1500 may be, for example, a desktop or laptop personal computer, a personal digital assistant (PDA), a smart mobile phone, a server, or any other suitable computing device. Network adapter 1504 may be any suitable hardware and/or software to enable the computing device 1500 to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media 1506 may be adapted to store data to be processed and/or instructions to be executed by processor 1502. Processor 1502 enables processing of data and execution of instructions.

The data and instructions stored on computer-readable storage media 1506 may comprise computer-executable instructions implementing techniques which operate according to the principles described herein. In the example of FIG. 15, computer-readable storage media 1506 stores computer-executable instructions implementing various facilities and storing various information as described above. Computer-readable storage media 1506 may store an opportunity scoring facility, which may score investment opportunities for an enterprise based on information about the enterprise. The computer-readable storage media 1506 may further comprise a survey facility 1510, which may survey one or more people affiliated with an enterprise electronically, such as by surveying the people using one or more web pages. Graphing facility 1512 may be stored in the computer-readable storage media 1506 and may implement techniques for creating a graphical comparison of investment opportunities. An analysis and reporting facility 1514 may analyze information regarding investments made by an enterprise or by multiple enterprises and produce information regarding the investment strategy of the enterprise(s). The computer-readable storage media 1506 may also store data to be processed by the facilities 1508-1514, including investment opportunity data 1516 that includes information regarding one or more characteristics of one or more investment opportunities and information 1518 on goals and/or expectations of one or more enterprises.

While not illustrated in FIG. 15, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

1. A method of operating at least one computing device to evaluate an investment opportunity to identify, for an enterprise, a value of the investment opportunity to the enterprise, the method comprising:
calculating, for the investment opportunity, a first numeric value indicating a strategic value of the investment opportunity to the enterprise, wherein calculating the first numeric value comprises operating at least one processor to:
receive, from at least one storage medium, a classification of the investment opportunity according to a plurality of capability deficits, the classification classifying the investment opportunity in one or more of the plurality of capability deficits;
receive, from the at least one storage medium, information regarding the one or more capability deficits, the information regarding the one or more capability deficits identifying, for each capability deficit, a numeric estimate of an impact that investments in the capability deficit will have in assisting the enterprise in achieving at least one goal of the enterprise;
calculate the first numeric value indicating the strategic value of the investment opportunity to the enterprise based at least in part on the one or more numeric estimates of the one or more capability deficits in which the investment opportunity is classified;
determining, using the at least one processor, a second numeric value indicating an estimated financial return on an investment in the investment opportunity; and
storing, in the at least one storage medium, information regarding the investment opportunity, the information for the investment opportunity comprising the first numeric value and the second numeric value.

2. The method of claim 1, further comprising:
creating a graphical comparison of one or more investment opportunities, the one or more investment opportunities comprising the investment opportunity, the graphical comparison comprising a coordinate system having at least two dimensions, a first dimension of the coordinate system being associated with estimated financial return on an investment and a second dimension of the coordinate system being associated with strategic value,
wherein creating the graphical comparison comprises including in the graphical comparison a graphical identifier for each investment opportunity of the one or more investment opportunities, and
wherein the graphical identifier for the investment opportunity is included in the graphical comparison at a location in the coordinate system corresponding to at least the first numeric value and the second numeric value for the investment opportunity.

3. The method of claim 2, further comprising:
displaying to a user, in a graphical user interface of a computing device, the graphical comparison of the plurality of investment opportunities.

4. The method of claim 2, wherein creating the graphical comparison comprises including in the graphical comparison a first graphical element identifying, for the first dimension of the coordinate system, a first threshold numeric value and a second graphical element identifying, for the second dimension of the coordinate system, a second threshold numeric value.

5. The method of claim 2, wherein:
the coordinate system of the graphical comparison has three dimensions, the third dimension being associated with other characteristic of investment opportunities; and
the graphical identifier for the investment opportunity is included in the graphical comparison at a location in the coordinate system corresponding to the first numeric value, the second numeric value, and a third numeric value of the other characteristic for the investment opportunity.

6. The method of claim 1, wherein:
the method further comprises receiving, for the investment opportunity, user input regarding an amount by which an engagement with the investment opportunity are estimated to assist the enterprise in achieving the at least one goal; and
calculating the first numeric value based at least in part on the one or more numeric estimates for the one or more capability deficits comprises calculating the first numeric value based at least in part on the amount.

7. The method of claim 1, wherein:
the method further comprises receiving, for the investment opportunity, user input of at least one amount, each amount of the at least one amount corresponding to an capability deficit of the one or more capability deficits in which the investment opportunity is classified and identifying an estimated amount by which an innovation, classified in the corresponding capability deficit, that is expected to result from the investment opportunity will assist the enterprise in achieving the at least one goal; and
calculating the first numeric value based at least in part on the one or more numeric likelihoods of the one or more capability deficits comprises calculating the first numeric value based at least in part on the at least one amount.

8. The method of claim 1, further comprising:
calculating, using the at least one processor, a first numeric estimate of an impact that investments in a first capability deficit will have in assisting the enterprise in achieving the at least one goal of the enterprise,
wherein the first numeric estimate is calculated based at least in part on information corresponding to each goal of a plurality of goals of the enterprise, the information corresponding to a goal comprising a first value indicating an importance to the enterprise of the corresponding goal and a second value indicating an amount of impact investments in the first capability deficit are estimated to have in assisting the enterprise in achieving the corresponding goal.

9. The method of claim 8, further comprising:
calculating, using the at least one processor, the first value corresponding to a goal and indicating the importance of the corresponding goal to the enterprise based at least in part on input provided by a plurality of persons affiliated with the enterprise, the input provided by each person of the plurality of persons comprising at least one value indicating a perceived importance to the enterprise of the corresponding goal as perceived by the person.

10. The method of claim 8, wherein:
calculating the first numeric estimate of an impact that investments in the first capability deficit will have in assisting the enterprise in achieving the at least one goal comprises calculating the first numeric estimate based at least in part on a third value indicating a likelihood that there will be innovation in the first capability deficit; and
the method further comprises calculating, using the at least one processor, the third value based at least in part on input provided by a plurality of persons affiliated with the enterprise and having experience in the capability deficit, the input provided by each person of the plurality of persons comprising a value indicating a perceived likelihood of innovation in the first capability deficit as perceived by the person.

11. The method of claim 1, wherein calculating the first numeric value comprises calculating the first numeric value for each of a plurality of investment opportunities where each investment opportunity is an opportunity to invest in an organization that is seeking to develop a technology.

12. The method of claim 1, wherein calculating the first numeric value comprises calculating the first numeric value for each of a plurality of investment opportunities where each investment opportunity is an opportunity to invest in a business that is seeking to commercialize an innovation.

13. The method of claim 1, wherein:
operating the at least one processor to receive the classification of the investment opportunity according to the plurality of capability deficits comprises receiving the classification of the investment opportunity according to a plurality of capability deficits in which at least one of the capability deficits is a field of technology, and
the investment opportunity is classified in the field of technology when the investment opportunity is expected to yield a technology innovation in the field of technology.

14. The method of claim 1, further comprising operating the at least one processor to:
receive user input identifying, for the investment opportunity, the classification of the first investment opportunity; and
store the classification in the at least one storage medium.

15. The method of claim 1, further comprising:
receiving user input provided via a graphical user interface of a computing device, the user input identifying the one or more capability deficits into which the investment opportunity is classified and identifying the estimated financial return on an investment in the investment opportunity,
wherein the information regarding the one or more capability deficits is stored in the at least one storage medium prior to receiving the user input.

16. The method of claim 15, wherein:
receiving the user input comprises receiving the user input from the computing device over at least one communication network; and
the method further comprises transmitting, to the computing device over the at least one communication network, an indication of the first numeric value and the second numeric value for the investment opportunity.

17. At least one computer-readable storage medium having encoded thereon computer-executable instructions that, when executed by at least one computing device, cause the at least one computing device to carry out a method of operating a system for evaluating investment opportunities for an enterprise, the method comprising:
establishing a plurality of capability deficits according to which investment opportunities for the enterprise are to be classified, wherein establishing the plurality of capability deficits comprises setting, for each category, a numeric estimate that investments in the capability deficit will assist the enterprise in achieving one or more goals of a plurality of goals for the enterprise; and
scoring an investment opportunity to provide an indication of a value the investment opportunity presents to the enterprise, wherein scoring the investment opportunity comprises determining a strategic value the investment opportunity presents to the enterprise and determining an estimated financial return on investment in the investment opportunity, wherein determining the strategic value presented by the investment opportunity comprises performing a calculation involving a first numeric estimate corresponding to a first capability deficit, of the plurality of capability deficits, into which the investment opportunity is classified.

18. The at least one computer-readable storage medium of claim 17, further comprising:
repeating the scoring for a plurality of investment opportunities to determine a strategic value and estimated financial return presented by each investment opportunity of the plurality of investment opportunities;
storing the strategic value and the estimated financial return for each investment opportunity of the plurality of investment opportunities in the at least one computer-readable storage medium.

19. The at least one computer-readable storage medium of claim 17, wherein:
the investment opportunity is further classified into a second plurality of capability deficits; and
performing the calculation comprises performing a calculation further involving a plurality of second numeric estimates each corresponding to a capability deficit of the second plurality of capability deficits.

20. The at least one computer-readable storage medium of claim 17, wherein establishing the plurality of capability deficits comprises calculating, for each capability deficit, the numeric estimate based at least in part on a numeric value indicating an expectation of future innovation in the capability deficit.

21. The at least one computer-readable storage medium of claim 20, wherein calculating the numeric estimate based at least in part on the numeric value comprises calculating the numeric estimate based at least in part on a second plurality of numeric values, each second numeric value of the second plurality of numeric values corresponding to a goal of the plurality of goals of the enterprise, each second numeric value indicating an expectation of an amount that an innovation in the capability deficit will assist the enterprise in achieving the corresponding goal.

22. The at least one computer-readable storage medium of claim 21, wherein calculating the numeric estimate further comprises calculating the numeric estimate based at least in part on a third plurality of numeric values, each third value of the second plurality of numeric values corresponding to a goal of the plurality of goals, each third numeric value indicating an importance to the enterprise of the corresponding goal.

23. An apparatus comprising:
at least one processor; and
at least storage medium having encoded thereon executable instructions that, when executed by the at least one processor, cause the at least one processor to carry out a method of operating a system for evaluating investment opportunities for an enterprise, the method comprising:
establishing a plurality of capability deficits according to which investment opportunities for the enterprise are to be classified, wherein establishing the plurality of capability deficits comprises setting, for each capability deficit, a numeric estimate that investments in the capability deficit will assist the enterprise in achieving one or more goals of a plurality of goals for the enterprise; and
scoring an investment opportunity to provide an indication of a value the investment opportunity presents to the enterprise, wherein scoring the investment opportunity comprises determining a strategic value the investment opportunity presents to the enterprise and determining an estimated financial return on investment in the investment opportunity, wherein determining the strategic value presented by the investment opportunity comprises performing a calculation involving a first numeric estimate corresponding to a first capability deficit, of the plurality of capability deficits, into which the investment opportunity is classified.
